(19) United States
(12) Patent Application Publication
(10) Pub. No.: US 2025/0285164 A1
(43) Pub. Date: Sep. 11, 2025

(54) AUTOMATED USER MATCHING USING DYNAMIC PRODUCT PARAMETERS

(71) Applicant: SavvyMoney, Inc., Pleasanton, CA (US)

(72) Inventor: JB Orecchia, Pleasanton, CA (US)

(21) Appl. No.: 19/071,715

(22) Filed: Mar. 5, 2025

Related U.S. Application Data
(60) Provisional application No. 63/562,154, filed on Mar. 6, 2024.

(51) Int. Cl. G06Q 30/0601

(52) U.S. Cl. CPC G06Q 30/0631; G06Q 30/0643

(57) ABSTRACT

A system may receive user identification information and determine various user attributes based on the user identification information. The system may determine various data describing various products. The data may describe product parameters, each of which may relate to a user attribute, tier, value of user attribute, or requirement, for example. In some implementations, the system may determine a set of matched products based on whether the determined user attributes satisfy the product parameters of the one or more products. The system may provide various graphical interfaces representing the set of matched products on a client device. In some implementations, the system may automatically track changes to user attributes and product parameters, compute matches, and provide customizable alert notifications, among other improvements.

### BACKGROUND

The present disclosure relates to a system for automated user matching against dynamic product parameters. Some implementations relate to continuously keeping matches, product parameters, user attributes, or other data updated in order to improve information display and decrease latency to users.

Previous systems that matched users with products or services were slow or required that they be manually refreshed, updated, or applied for again. Additionally, previous interfaces were not customized to users, institutions, or other contexts. Because these systems failed to intelligently use data and interfaces, not only were they less secure and less useful, but they also required significantly more computational resources, especially when compounded over multiple products or users.

### SUMMARY

An automated user-product matching system can be configured to perform particular operations or actions by virtue of having software, firmware, hardware, or a combination of them installed on the system that in operation causes or cause the system to perform the actions. Similarly, various hardware components are described that improve picking technologies, including over those issues described in the Background.

In some aspects, the techniques described herein relate to a computer-implemented method including: receiving, by one or more processors, user identification information; determining, by the one or more processors, one or more user attributes based on the user identification information; determining, by the one or more processors, one or more data sets describing one or more products, each of the one or more data sets including one or more product parameters, each of the one or more product parameters being associated with a user attribute; determining, by the one or more processors, a set of matched products based on whether the one or more user attributes satisfy the one or more product parameters of the one or more products; and providing, by the one or more processors to a client device, one or more graphical interfaces representing the set of matched products.

In some aspects, the techniques described herein relate to a computer-implemented method, further including: automatically updating, by the one or more processors, at least one of the one or more user attributes and the one or more product parameters; and providing, by the one or more processors, the one or more graphical interfaces representing the automatically updated data to the client device.

In some aspects, the techniques described herein relate to a computer-implemented method, wherein: providing the one or more graphical interfaces representing the automatically updated data includes displaying a graphical element indicating a percent match between the one or more user attributes and the one or more product parameters.

In some aspects, the techniques described herein relate to a computer-implemented method, further including: determining, by the one or more processors, an updated set of matched products based on the automatically updated at least one of the one or more user attributes and the one or more product parameters; and providing, by the one or more processors, the one or more graphical interfaces including graphically representing the automatically updated data on the client device.

In some aspects, the techniques described herein relate to a computer-implemented method, wherein: automatically updating the at least one of the one or more user attributes and the one or more product parameters includes automatically determining one or more changes to the one or more user attributes; and determining the updated set of matched products includes detecting that the one or more user attributes matches a product parameter of an additional product of the one or more products.

In some aspects, the techniques described herein relate to a computer-implemented method, further including: automatically querying, by the one or more processors, one or more third-party servers to determine one or more of updated user attributes and updated product parameters; and determining, by the one or more processors, one or more new matches from among the one or more products, the one or more new matches being separate from the set of matched products.

In some aspects, the techniques described herein relate to a computer-implemented method, wherein: automatically querying the one or more third-party servers is performed at a defined frequency period; and providing the one or more graphical interfaces representing the set of matched products includes automatically providing a notification to the client device based on the one or more new matches.

In some aspects, the techniques described herein relate to a computer-implemented method, including: determining, by the one or more processors, a change to at least one of the one or more user attributes and the one or more product parameters; automatically computing, by the one or more processors, a proximity of the one or more user attributes to the one or more product parameters; and displaying, by the one or more processors, a graphical indication of the proximity in the one or more graphical interfaces.

In some aspects, the techniques described herein relate to a computer-implemented method, further including: determining, by the one or more processors, an alert respective to a particular product type of the one or more products, the alert indicating a target term for the particular product type; determining, by the one or more processors, that the target term is satisfied based on the change to the at least one of the one or more user attributes and the one or more product parameters; and displaying, by the one or more processors, a notification indicating the alert.

In some aspects, the techniques described herein relate to a computer-implemented method, further including: determining, by the one or more processors, guidance information based on the proximity of the one or more user attributes to the one or more product parameters; and providing, by the one or more processors, the guidance information to the client device.

In some aspects, the techniques described herein relate to a system including: one or more processors; and one or more computer-readable memories storing instructions that, when executed by the one or more processors, causes the system to perform operations including; receiving user identification information; determining one or more user attributes based on the user identification information; determining one or more data sets describing one or more products, each of the one or more data sets including one or more product parameters, each of the one or more product parameters being associated with a user attribute; determining a set of matched products based on whether the one or more user attributes satisfy the one or more product parameters of the one or more products; and providing, to a client device, one or more graphical interfaces representing the set of matched products.

In some aspects, the techniques described herein relate to a system, wherein the operations further include: automatically updating at least one of the one or more user attributes and the one or more product parameters; and providing the one or more graphical interfaces representing the automatically updated data to the client device.

In some aspects, the techniques described herein relate to a system, wherein: providing the one or more graphical interfaces representing the automatically updated data includes displaying a graphical element indicating a percent match between the one or more user attributes and the one or more product parameters.

In some aspects, the techniques described herein relate to a system, wherein the operations further include: determining an updated set of matched products based on the automatically updated at least one of the one or more user attributes and the one or more product parameters; and providing the one or more graphical interfaces including graphically representing the automatically updated data on the client device.

In some aspects, the techniques described herein relate to a system, wherein: automatically updating the at least one of the one or more user attributes and the one or more product parameters includes automatically determining one or more changes to the one or more user attributes; and determining the updated set of matched products includes detecting that the one or more user attributes matches a product parameter of an additional product of the one or more products.

In some aspects, the techniques described herein relate to a system, wherein the operations further include: automatically querying one or more third-party servers to determine one or more of updated user attributes and updated product parameters; and determining one or more new matches from among the one or more products, the one or more new matches being separate from the set of matched products.

In some aspects, the techniques described herein relate to a system, wherein: automatically querying the one or more third-party servers is performed at a defined frequency period; and providing the one or more graphical interfaces representing the set of matched products includes automatically providing a notification to the client device based on the one or more new matches.

In some aspects, the techniques described herein relate to a system, wherein the operations further include: determining, by the one or more processors, a change to at least one of the one or more user attributes and the one or more product parameters; automatically computing, by the one or more processors, a proximity of the one or more user attributes to the one or more product parameters; and displaying, by the one or more processors, a graphical indication of the proximity in the one or more graphical interfaces.

In some aspects, the techniques described herein relate to a system, wherein the operations further include: determining an alert respective to a particular product type of the one or more products, the alert indicating a target term for the particular product type; determining, by the one or more processors, that the target term is satisfied based on the change to the at least one of the one or more user attributes and the one or more product parameters; and displaying, by the one or more processors, a notification indicating the alert.

In some aspects, the techniques described herein relate to a system, wherein the operations further include: determining guidance information based on the proximity of the one or more user attributes to the one or more product parameters; and providing the guidance information to the client device.

Other implementations of one or more of these aspects include corresponding systems, apparatus, and computer programs, configured to perform the actions of the methods, encoded on computer storage devices.

It should be understood that the language used in the present disclosure has been principally selected for readability and instructional purposes, and not to limit the scope of the subject matter disclosed herein.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a block diagram of an example system for providing a system for automated user matching against dynamic product parameters.

FIG. 2 is a block diagram of an example computing system.

FIGS. 3A and 3B depict a flowchart of an example method for automated user matching against dynamic product parameters.

FIG. 4A illustrates an example graphical user interface in which the matching and personalization engine may display an indication of one or more product matches.

FIG. 4B illustrates an example graphical user interface in which the matching and personalization engine may display a filterable list of product matches.

FIGS. 4C, 4D, and 4E illustrate example graphical user interfaces that allow the user to quickly filter the matched and/or unmatched products.

FIGS. 4F and 4G illustrate example graphical user interfaces displaying various product offers.

FIG. 4H illustrates an example graphical user interface, which may represent a detailed view for a particular offer.

FIG. 4I illustrates an example graphical user interface via which a user may define parameters of an alert.

FIG. 4J illustrates an example graphical user interface in which a confirmation of the alert and its terms may be displayed to a user.

FIG. 4K illustrates an example graphical user interface in which a user may define notification preferences for an alert.

FIGS. 4L, 4M, and 4N illustrate example graphical user interfaces which may include a dashboard providing information and offers customized to the user and/or institution.

FIG. 4O illustrates an example graphical user interface which may include a mobile dashboard providing product match information.

FIG. 4P illustrates an example graphical user interface including an example notification for an alert.

FIG. 4Q illustrates an example graphical user interface displaying various matched products or offers.

FIG. 4R illustrates an example graphical user interface including an overlayed popup indicating a product matching status.

FIG. 4S illustrates an example graphical user interface indicating an example score analysis.

FIGS. 4T and 4U illustrate example graphical user interfaces displaying matching analytics calculators.

FIG. 4V illustrates an example graphical user interface displaying analytics for various attributes, parameters, or matches.

### DESCRIPTION

The present disclosure relates to a tool for automated user matching against dynamic product parameters. For instance, the technology described herein efficiently determines user attributes, determines product or service parameters, and matches a user with products or services. In some implementations, the technology classifies the user based on the interaction between user attribute and product parameters, the technology may dynamically classify a user into one or more categories and may, accordingly, customize graphical interfaces and other user experience elements on a client device 106, among other improvements. By reducing tangential or extraneous data displayed to the user, while providing improved monitoring and adaptability, the system both improves the graphical interfaces and user experience, but also reduces bandwidth and processor utilization, especially in implementations where the data and matches are being updated frequently or continuously, which, otherwise, would consume excessive resources and lead to system stability issues along with increased latency to user requests. Accordingly, the operations and features described herein may improve computer technology and interfaces over previous technologies, such as those described in the background.

While other implementations are possible and contemplated herein, the technology may be applied in context of user interactions, for example, via an online banking interface of the user's bank, with financial products and services, such as loans, credit cards, financial counseling services, or other products/services. While this context is provided as an example herein, the technology may also be applied in other computer technologies, such as where the user is seeking to purchase a product/service, where the user's attributes (e.g., physical features, eye spacing, preferences, etc.) are being matched with computational features that are functionally relevant to the user (e.g., a virtual reality headset, virtual buttons that match the user's interpupillary distance or motion sensitivities), or a user's attributes against any other parametric resource. For instance, these other implementations may use continuous or periodic monitoring of user attributes, product attributes, and/or the matching thereof, which provides adaptable interfaces or other features.

For instance, implementations of the technology may include a service for which end users may sign up via their on-line banking portal (e.g., credit score services and offers). Example implementations of some of these aspects may be referred to and/or executed using a continuous qualification module 228 and/or matching and personalization engine 108 herein, where end users may sign up to receive match indications (e.g., which may be referred to as offers) and for the matching and personalization engine 108 service through a website (e.g., operated by an application server 122 associated with matching and personalization engine 108) and then link to the user's online bank (e.g., which may provide offers, credit score services, offer parameters, user attributes, or other data). The application server 122 may include a consumer-facing web and/or mobile-friendly application that provides graphical call-to-action elements that allow users to enter personal information and, in turn, display matching products or features for which they are pre-qualified.

The continuous qualification module 228, matching and personalization engine 108 services, or other technologies described herein may be implemented one or more instances of logical code operating on computing devices, as described in further detail below. These instances of code may be operable on a single computing device or multiple computing devices in collaboration. For instance, a first component of the code may be executed on a first device, such as an institution's server or a client device 106 to access, send data to, receive data from, or otherwise interact with a second component of the code operating on one or more servers, such as an application server 122, though other implementations are possible. The logical code may be described herein in terms of the matching and personalization engine 108, continuous qualification module 228, or other components, which may be operated as separate, interconnected, or components of the logical code.

Each instance of the matching and personalization engine 108, interface, or environment thereof may be branded or otherwise customized for a specific server (e.g., of a technology provider, financial institution, etc.) and have required offer logic, rates, disclosures, and application forms. The continuous qualification module 228 may provide a path (e.g., through user interfaces, operations, or logic) for each user depending on their context, such as where the user falls on the credit spectrum—for instance, users with a certain attribute (e.g., good credit, in a certain geographical location, with a certain client device 106 type, etc.) may be allowed by the matching and personalization engine 108 to apply immediately while user without that attribute may be allowed to access tools and guidance to improve that attribute (e.g., their credit situation on their path toward approval).

The continuous qualification module 228 provided by the matching and personalization engine 108 may be an on-going service that allows users to set alerts when they receive better matches (e.g., improved offers) and/or allows access to certain product or software features, such as credit improvement tools and track the user's progress over multiple sessions (whether internally via certain application server 122 features and/or externally via the continuous qualification module 228, such as a credit score, user preference, or other attribute).

The matching and personalization engine 108 may provide an end-user facing web and/or mobile-web application that invites users to enroll and receive services, such as: review their variable attributes (e.g., a credit score and/or credit report) online or via a dedicated local application; enroll in alerts that notify the user when there are updates on their attributes; receive personalized guidance on how to improve that attribute (e.g., improve a credit-worthiness and financial well-being); access to certain application server 122 or related tool (e.g., financial well-being tools, such as goal setting and credit score simulators); see a list of multiple personalized, pre-qualified (e.g., pre-qualified may indicate that that a particular offer is recommended for a specific user, based upon their credit report, data provided by the user, and/or other attributes or behaviors, which may be an invitation to apply for credit, not a guarantee of approval) offers they may qualify for; apply for credit offers within the application and get a real-time response; or configure rate notifications so that they receive updates when their offers improve by a certain percentage (e.g., default), or when a defined target rate or payment comes available.

Each instance or user experience environment of the matching and personalization engine 108, service provided by the matching and personalization engine 108, or access to the matching and personalization engine 108 may be branded or otherwise customized for a particular institution (e.g., financial institution) to provide access to offer logic, rates, disclosures, and application forms. For instance, the matching and personalization engine 108 may, in advance or in real time as the user navigates the website, determine that a user is accessing the matching and personalization engine 108 or its services via a given institution server 112 (e.g., of a certain bank) and may automatically serve a version of the matching and personalization engine 108 and its user experience based on the institution (e.g., associated with the server or associated with a user's profile) or may update certain forms, features, tools, or graphical elements of the graphical user experience based on a database of associated graphical elements associated with the institution. For instance, the matching and personalization engine 108 may determine that a user is accessing the matching and personalization engine 108 from a first institution server 112, identify data assets (e.g., local decision trees, logos, textual information or instructions, documents, media, parameters, attributes, or other data) associated with that institution, and insert them into defined placeholders in the graphical elements of interfaces provided by the matching and personalization engine 108. It should be noted that although the matching and personalization engine 108 may use information from a given institution server 112, in some instances, the user may not need a current profile or account with the server or an associated financial institution to use the matching and personalization engine 108 or other technologies described herein.

In some implementations, the matching and personalization engine 108 may update continuously or periodically, use a credit score, use other user attributes, or use other dynamic information to provide matches against financial products/services, such as loans, without impacting the user's credit rating (e.g., where the user may otherwise be required to apply and get a pre-qualification decision), as noted in further detail elsewhere herein. While, in some instances, final credit approval may require the user to formally apply for an offer of a matched product/service, the matching and personalization engine 108 may allow the user to apply directly via the matching and personalization engine 108 itself. For instance, the matching and personalization engine 108 may receive product information, forms, and/or parameters (e.g., for matching or qualifications) or it may interact with a third-party server 118 of the provider of a product via an application programming interface to provide a unified user experience using the matching and personalization engine 108 even while interacting with disparate products.

Accordingly, as reflected throughout this description, not only does the technology described herein improve utilization of computational resources, it also enables monitoring of user attributes, automatic education relating to the user attributes, automatic education relating to matched products or potentially matched products (e.g., based on a changed user attribute or product parameter), automated alerting for matching or otherwise (e.g., pre-qualified rates on offers, improved rates, etc.) based on user attributes (e.g., a user's credit worthiness or their preferences for a rate or terms of a product).

These and other features are described in further detail in reference to the figures below. The features and advantages described herein are not all-inclusive and many additional features and advantages are within the scope of the present disclosure. Moreover, it should be noted that the language used in the present disclosure has been principally selected for readability and instructional purposes, and not to limit the scope of the subject matter disclosed herein.

With reference to the figures, reference numbers may be used to refer to example components found in any of the figures, regardless of whether those reference numbers are shown in the figure being described. Further, where a reference number includes a letter referring to one of multiple similar components (e.g., component 000a, 000b, and 000n), the reference number may be used without the letter to refer to one or all of the similar components.

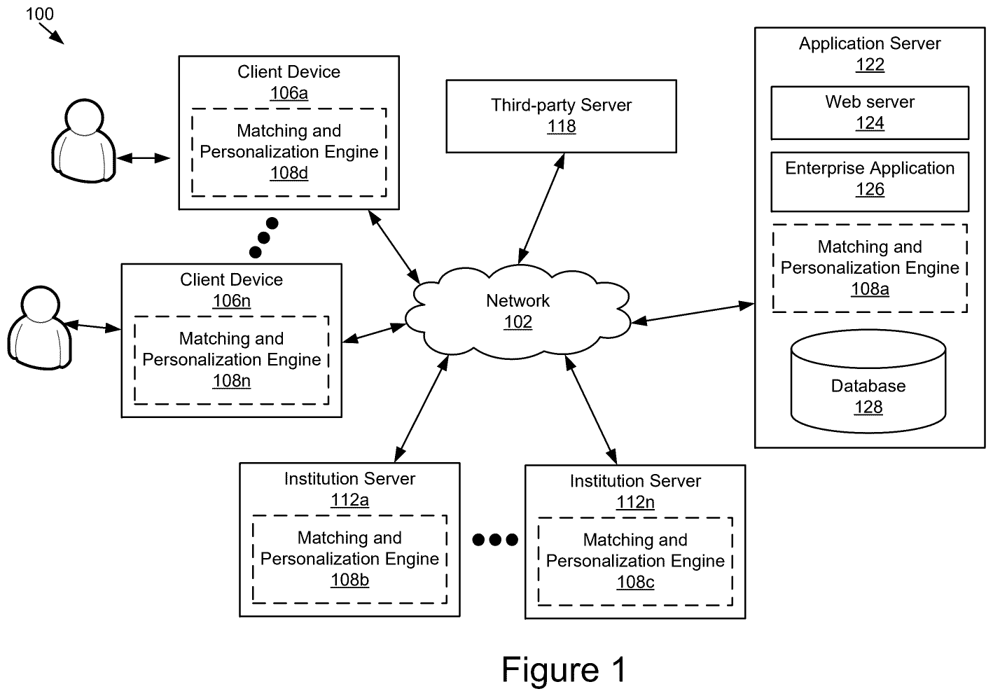

FIG. 1 is a block diagram of an example system 100 for providing a system for automated user matching against dynamic product parameters. The illustrated system 100 may include client devices 106a . . . 106n, a third-party server 118, one or more institution servers 112a . . . 112n, and an application server 122, which may run one or more instances of the matching and personalization engine 108a . . . 108n and which devices may be electronically communicatively coupled via a network 102 for interaction with one another, although other system configurations are possible including other devices, systems, and networks. For example, the system 100 could include any number of client devices 106, third-party servers 118, institution servers 112 122, application servers 122, and other systems and devices.

The network 102 may include any number of networks and/or network types. For example, the network 102 may include, but is not limited to, one or more local area networks (LANs), wide area networks (WANs) (e.g., the Internet), virtual private networks (VPNs), wireless wide area network (WWANs), WiMAX® networks, personal area networks (PANs) (e.g., Bluetooth® communication networks), various combinations thereof, etc. These private and/or public networks may have any number of configurations and/or topologies, and data may be transmitted via the networks using a variety of different communication protocols including, for example, various Internet layer, transport layer, or application layer protocols. For example, data may be transmitted via the networks using TCP/IP, UDP, TCP, HTTP, HTTPS, DASH, RTSP, RTP, RTCP, VOIP, FTP, WS, WAP, SMS, MMS, XMS, IMAP, SMTP, POP, WebDAV, or other known protocols.

The client device 106 (s) 106 includes one or more computing devices having data processing and communication capabilities. The client device 106 may couple to and communicate with other client devices 106 and the other entities of the system 100 via the network 102 using a wireless and/or wired connection, such as the application server 122. Examples of client devices 106 may include, but are not limited to, mobile phones, wearables, tablets, laptops, desktops, netbooks, server appliances, servers, virtual machines, TVs, etc. The system 100 may include any number of client devices 106, including client devices 106 of the same or different type.

A plurality of client devices 106a . . . 106n are depicted in FIG. 1 to indicate that the application server 122 and its components may aggregate information about and provide data associated with the systems and processes described herein to a multiplicity of users on a multiplicity of client devices 106a . . . 106n, for example, as described in reference to various users and client devices 106 described herein. In some implementations, a single user may use more than one client device 106a . . . 106n, which the application server 122 may use to track and aggregate interaction data associated with the user through a variety of different channels including online, physical, and phone (e.g., text, voice, etc.) channels, as discussed elsewhere herein. In some implementations, multiple users may use multiple client devices 106 and the matching and personalization engine 108, whether on a client device 106, on an institution server 112, and/or on an application server 122 (or another component) may provide interaction and functionality described herein. In some implementations, the application server 122 may communicate with and provide information directly to a client device 106 or the communication may be from or through an institution server 112.

In some implementations, the matching and personalization engine 108 may send information to another computing device, for example, to an application server 122 or third-party server 118. For example, the matching and personalization engine 108 may determine certain information and communicate with various devices based on those details. In some instances, the application server 122 may crawl other websites, forums, or databases (e.g., hosted by a third-party server 118) to identify the products/services and associated data.

In some implementations, the application server 122 may include a web server 124, an enterprise application 126, a matching and personalization engine 108, and a database 128. In some configurations, the enterprise application 126 and/or matching and personalization engine 108b may be distributed over the network 102 on disparate devices in disparate locations or may reside on the same locations, in which case the client device 106a and/or the application server 122 may each include an instance of the matching and personalization engine 108 and/or portions thereof. The client devices 106 or institution servers 112 may also store and/or operate other software such as a matching and personalization engine 108, an operating system, other applications, etc., that are configured to interact with the application server 122 via the network 102.

The application server 122, institution server(s) 112, and the third-party server 118 have data processing, storing, and communication capabilities, as discussed elsewhere herein. For example, the servers 122, 112, and/or 118 may include one or more hardware servers, server arrays, storage devices and/or systems, etc. In some implementations, the servers 122 and/or 118 may include one or more virtual servers, which operate in a host server environment.

In some implementations, the enterprise application 126 may receive communications from a client device 106 directly or via an institution server 112 in order to perform the functionality described herein. The enterprise application 126 may receive information and provide information to the matching and personalization engine 108 to generate the adaptable graphical interfaces described herein, as well as perform and provide analytics and other operations. In some implementations, the enterprise application 126 may perform additional operations and communications based on the information received from client devices 106.

The database 128 may be stored on one or more information sources for storing and providing access to data, such as the data storage device 208. The database 128 may store data describing client devices 106, instances of the matching and personalization engine 108, customers, users, products, attributes, parameters, guidance, thresholds, etc., such as described herein.

The system 100 may include one or more institution servers 112a . . . 112n, which may include some or all of the hardware or software of the application server 122. In some implementations, an institution server 112 may correspond to the system of a bank, which may provide online banking, account access, or other information or interaction. The matching and personalization engine 108 may be operable on or accessible via each of one or more institution servers 112a . . . 112n, although, in some instances, the matching and personalization engine 108 may be operable on the application server 122 and have access to the institution servers 112 or third-party server(s) 118 via application programming interfaces.

A third-party server 118 can host services such as a third-party application (not shown), which may be individual and/or incorporated into the services provided by the application server 122. For example, the third-party server 118 may represent one or more item databases, forums, company websites, etc. For instance, the third-party server 118 may provide user data/attributes, product information and parameters, credit scores, financial guidance or analysis, or other data. The third-party server 118 may communicate with the matching and personalization engine 108 directly or via another component on the institution server 112 or application server 122.

It should be understood that the system 100 illustrated in FIG. 1 is representative of an example system and that a variety of different system environments and configurations are contemplated and are within the scope of the present disclosure. For instance, various acts and/or functionality may be moved from a server to a client, or vice versa, data may be consolidated into a single data store or further segmented into additional data stores, and some implementations may include additional or fewer computing devices, services, and/or networks, and may implement various functionality client or server-side. Further, various entities of the system may be integrated into a single computing device or system or divided into additional computing devices or systems, etc.

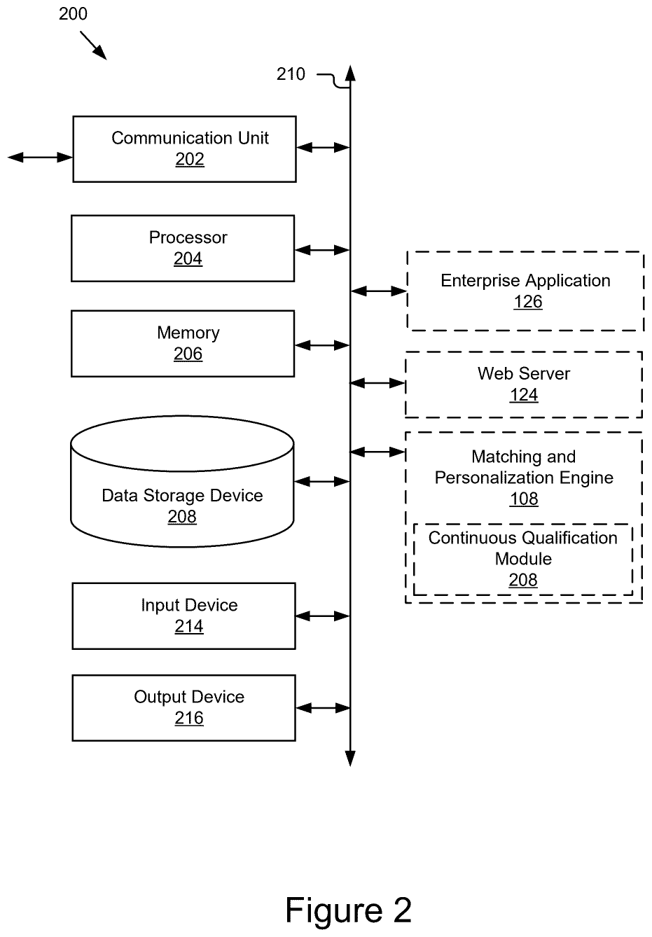

FIG. 2 is a block diagram of an example computing system 200, which may represent the computer architecture of a client device 106, institution server 112, third-party server 118, application server 122, and/or another device described herein, depending on the implementation. In some implementations, as depicted in FIG. 2, the computing system 200 may include an enterprise application 126, a web server 124, a matching and personalization engine 108, or another application, depending on the configuration. These components may be executed on the application server 122 126, institution server 112, and/or third-party server 118, for example. For instance, a client device 106 may include or interact with a matching and personalization engine 108 (which could incorporate various aspects of the enterprise application 126, in some implementations); the institution server 112 may include an instance of the matching and personalization engine 108 or may access it on an application server 122; and the application server 122 may include the web server 124, the enterprise application 126, matching and personalization engine 108, and/or components thereof, although other configurations are also possible and contemplated.

The enterprise application 126 includes computer logic executable by the processor 204 to perform operations discussed elsewhere herein. For instance, the enterprise application 126 may be coupled to the data storage device 208 to store, retrieve, and/or manipulate data stored therein and may be coupled to the web server 124, the matching and personalization engine 108, and/or other components of the system 100 to exchange information therewith. In some implementations, the enterprise application 126 may perform other functions for an institution and/or may be included, executed, or accessible via or to the institution server 112. For example, depending on the implementation, the enterprise application 126 may provide banking services, loan applications, or otherwise.

The web server 124 includes computer logic executable by the processor 204 to process content requests (e.g., to or from a client device 106). The web server 124 may include an HTTP server, a REST (representational state transfer) service, or other suitable server type. The web server 124 may receive content requests (e.g., product search requests, HTTP requests) from client devices 106, cooperate with the enterprise application 126 and/or matching and personalization engine 108 to determine content, retrieve and incorporate data from the data storage device 208, format the content, and provide the content to the client devices 106.

In some instances, the web server 124 may format the content using a web language and provide the content to a corresponding matching and personalization engine 108 for processing and/or rendering to the user for display. The web server 124 may be coupled to the data storage device 208 to store retrieve, and/or manipulate data stored therein and may be coupled to the enterprise application 126 to facilitate its operations.

The matching and personalization engine 108 includes computer logic executable by the processor 204 on a client device 106 to provide for user interaction, receive user input, present information to the user via a display, and send data to and receive data from the other entities of the system 100 via the network 102. In some implementations, the matching and personalization engine 108 may generate and present user interfaces based on information received from the enterprise application 126 and/or the web server 124 via the network 102. For example, the matching and personalization engine 108 to perform the operations described herein.

In some implementations, a continuous qualification module 228 may be integrated into or accessible by the matching and personalization engine 108. The continuous qualification module 228 may continuously, or at a defined or dynamic interval, receive or retrieve user attributes and/or product/feature parameters. The continuous qualification module 228 may provide matches, track alerts, and/or provide guidance separately or in conjunction with the matching and personalization engine 108. Additional features and details are described elsewhere herein.

As depicted, the computing system 200 may include a processor 204, a memory 206, a communication unit 202, an output device 216, an input device 214, and a data storage device 208, which may be communicatively coupled by a communication bus 210. The computing system 200 depicted in FIG. 2 is provided by way of example and it should be understood that it may take other forms and include additional or fewer components without departing from the scope of the present disclosure. For instance, various components of the computing devices may be coupled for communication using a variety of communication protocols and/or technologies including, for instance, communication buses, software communication mechanisms, computer networks, etc. While not shown, the computing system 200 may include various operating systems, sensors, additional processors, and other physical configurations. The processor 204, memory 206, communication unit 202, etc., are representative of one or more of these components.

The processor 204 may execute software instructions by performing various input, logical, and/or mathematical operations. The processor 204 may have various computing architectures to method data signals (e.g., CISC, RISC, etc.). The processor 204 may be physical and/or virtual and may include a single core or plurality of processing units and/or cores. In some implementations, the processor 204 may be coupled to the memory 206 via the bus 210 to access data and instructions therefrom and store data therein. The bus 210 may couple the processor 204 to the other components of the computing system 200 including, for example, the memory 206, the communication unit 202, the input device 214, the output device 216, and the data storage device 208.

The memory 206 may store and provide access to data to the other components of the computing system 200. The memory 206 may be included in a single computing device or a plurality of computing devices. In some implementations, the memory 206 may store instructions and/or data that may be executed by the processor 204. For example, the memory 206 may store one or more of the enterprise application 126, the web server 124, the matching and personalization engine 108, and their respective components, depending on the configuration. The memory 206 is also capable of storing other instructions and data, including, for example, an operating system, hardware drivers, other software applications, databases, etc. The memory 206 may be coupled to the bus 210 for communication with the processor 204 and the other components of computing system 200.

The memory 206 may include a non-transitory computer-usable (e.g., readable, writeable, etc.) medium, which can be any non-transitory apparatus or device that can contain, store, communicate, propagate or transport instructions, data, computer programs, software, code, routines, etc., for processing by or in connection with the processor 204, such as the enterprise application 126, web server 124, matching and personalization engine 108, and/or continuous qualification module 228. In some implementations, the memory 206 may include one or more of volatile memory and non-volatile memory (e.g., RAM, ROM, hard disk, optical disk, etc.). It should be understood that the memory 206 may be a single device or may include multiple types of devices and configurations.

The bus 210 can include a communication bus for transferring data between components of a computing device or between computing devices, a network bus system including the network 102 or portions thereof, a processor mesh, a combination thereof, etc. In some implementations, the enterprise application 126, continuous qualification module 228, web server 124, matching and personalization engine 108, and various other components operating on the computing system/device 100 (operating systems, device drivers, etc.) may cooperate and communicate via a communication mechanism included in or implemented in association with the bus 210. The software communication mechanism can include and/or facilitate, for example, inter-method communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

The communication unit 202 may include one or more interface devices (I/F) for wired and wireless connectivity among the components of the system 100. For instance, the communication unit 202 may include, but is not limited to, various types known connectivity and interface options. The communication unit 202 may be coupled to the other components of the computing system 200 via the bus 210. The communication unit 202 can provide other connections to the network 102 and to other entities of the system 100 using various standard communication protocols.

The input device 214 may include any device for inputting information into the computing system 200. In some implementations, the input device 214 may include one or more peripheral devices. For example, the input device 214 may include a keyboard, a pointing device, microphone, an image/video capture device (e.g., camera), a touchscreen display integrated with the output device 216, etc. The output device 216 may be any device capable of outputting information from the computing system 200. The output device 216 may include one or more of a display (LCD, OLED, etc.), a printer, a haptic device, audio reproduction device, touch-screen display, a remote computing device, etc. In some implementations, the output device is a display which may display electronic images and data output by a processor of the computing system 200 for presentation to a user, such as the processor 204 or another dedicated processor. In some implementations, the input device 214 may include an optical scanner or sensor, such as a camera that captures images, video, or other data.

In some implementations, the communication unit 202 or input device 214 may include a location sensor, such as various radios or receivers that may be used to receive information, for example, for locating the device 200 (e.g., a client device 106). In some instances, a cellular, Wi-Fi™, or Bluetooth™ radio may be used to determine a location of a client device 106, for example, by detecting a cell tower, router, or beacon. In some instances, the input device 214 may additionally or alternatively include a GPS sensor for receiving GPS signals and determining a geographic location of the device.

The data storage device 208 may include one or more information sources for storing and providing access to data. In some implementations, the data storage device 208 may store data associated with a database management system (DBMS) operable on the computing system 200. For example, the DBMS could include a structured query language (SQL) DBMS, a NoSQL DMBS, various combinations thereof, etc. In some instances, the DBMS may store data in multi-dimensional tables comprised of rows and columns, and manipulate, e.g., insert, query, update and/or delete, rows of data using programmatic operations.

The data stored by the data storage device 208 may be organized and queried using various criteria including any type of data stored by them, such as in one or more databases (e.g., user profiles, user attributes, products/services, product information, product parameters, guidance, other information described herein, etc.), such as described herein. For example, the data storage device 208 may store the database 128. The data storage device 208 may include data tables, databases, or other organized collections of data. Examples of the types of data stored by the data storage device 208 may include, but are not limited to, the data described with respect to the figures, for example.

The data storage device 208 may be included in the computing system 200 or in another computing system and/or storage system distinct from but coupled to or accessible by the computing system 200. The data storage device 208 can include one or more non-transitory computer-readable mediums for storing the data. In some implementations, the data storage device 208 may be incorporated with the memory 206 or may be distinct therefrom.

The components of the computing system 200 may be communicatively coupled by the bus 210 and/or the processor 204 to one another and/or the other components of the computing system 200. In some implementations, the components may include computer logic (e.g., software logic, hardware logic, etc.) executable by the processor 204 to provide their acts and/or functionality. In any of the foregoing implementations, the components may be adapted for cooperation and communication with the processor 204 and the other components of the computing system 200.

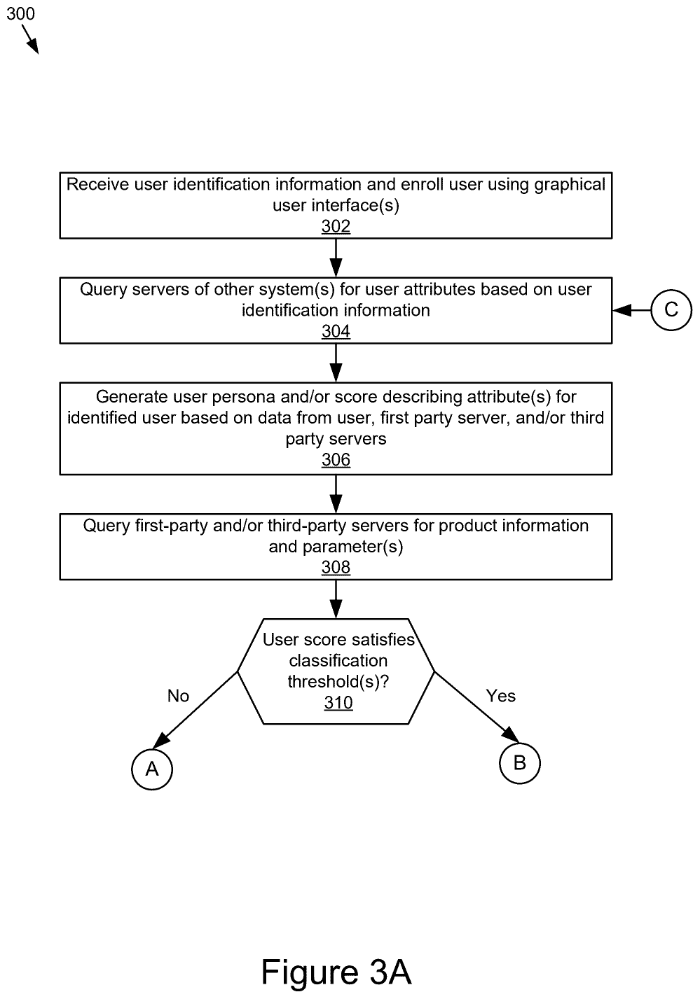

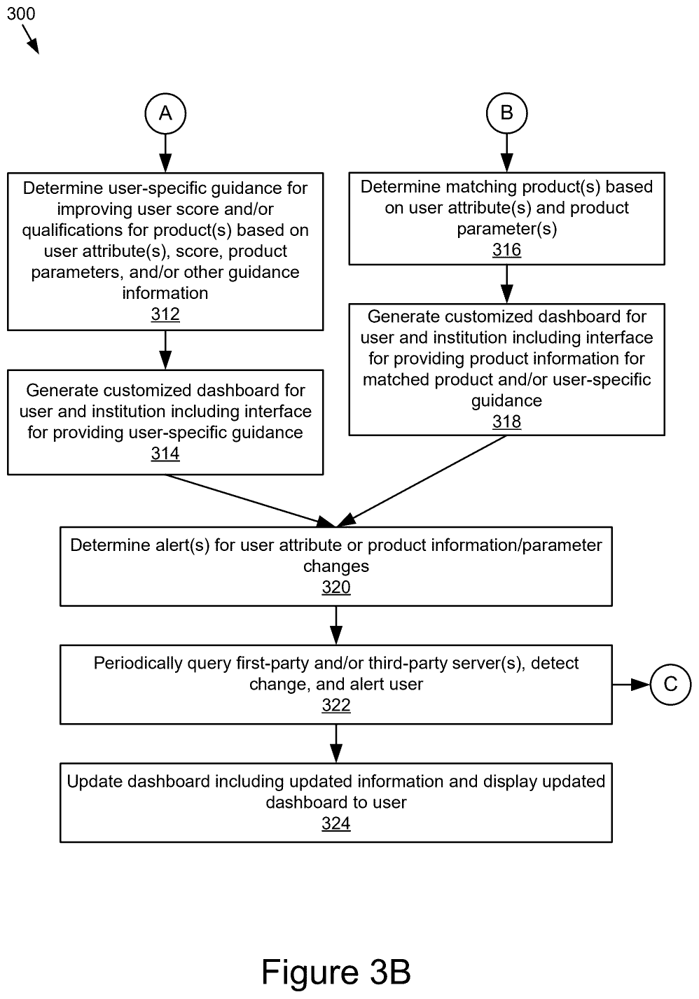

FIGS. 3A and 3B depict a flowchart of an example method 300 for automated user matching against dynamic product parameters. For example, FIGS. 3A and 3B illustrate a method that may include operations in which user attributes are determined and updated, product information and parameters are determined and updated, matches are performed and updated, and customized information respective to these attributes, parameters, and matches are determined and updated. Among other things, the example method 300 may include generating a dashboard for a branded instance of a matching and personalization engine 108 or aspects of graphical user interfaces for an institution. In some instances, the matching and personalization engine 108 may automatically customize graphical elements determined for an institution, as noted above, such as logos and other information specific to a bank that brands the instance for the bank.

At 302, the matching and personalization engine 108 may receive user identification information and enroll the user using one or more graphical user interfaces. In some implementations, the matching and personalization engine 108 may receive a user sign-in and/or initial information, for example, from the user via the client device 106 and/or institution server 112. For example, an institution server 112 may store a user profile, which it may share with the matching and personalization engine 108 in order to determine some or all of the required attributes for a user. The user may provide certain information, which may include or be used by the matching and personalization engine 108 to determine the user's attributes. For example, the user and/or institution server 112 may determine the user's account data, bank account balance, transaction history, social security number, income information, or other data from the user's inputs and/or user's profile in a data store.

At 304, the matching and personalization engine 108 may query one or more servers of other systems, such as the application server 122, other institutions, or third-party servers, for user attributes using the user identification information. For instance, in addition to the information provided by the user, the matching and personalization engine 108 may query other systems, such as a third-party server 118 of a credit bureau via one or more application programming interfaces. In some instances, the matching and personalization engine 108 may identify other information from the servers of other banks, user analytics services, or other devices.

At 306, the matching and personalization engine 108 may generate a user persona, which may include attributes and/or a score for the identified user. The persona may be based on data received from the user, a first-party server (e.g., an institution server 112), and/or third-party servers. For instance, the persona may represent a set or data table indicating attributes of the user. The persona may include a score (e.g., a credit score, though this is only an example), or one or more scores may be generated based on other user attributes. The score may reflect, among other things, for example, a relative score for a user attribute, such as a strength of one or more of the user's attributes, such as their income strength, their repayment ability, or other attributes. The persona, attributes, and/or scores may be used to classify a user and/or match them to various parameters such as those of products/services as well as customize a user experience to the users, as noted elsewhere herein. In some instances, the user attributes May indicate attributes about the user's client device 106, such as its location, type, screen resolution, specifications, etc.

At 308, the matching and personalization engine 108 may query a first-party server and/or one or more third-party servers for product information or parameters. It should be noted that although the term “product” is used herein, it may refer to physical or digital products, services, loans, software features, digital tools, applications, or other products. For instance, the matching and personalization engine 108 may communicate with one or more institution servers 112, third-party servers 118, or application servers 122 to determine and aggregate available products via APIs or other means. In some implementations, available products and associated information may be stored on a database 128 of the application server 122 or otherwise available to the matching and personalization engine 108. In some instances, the attributes/persona/score(s) of the user may be used when querying the server(s)/database(s) in order to reduce the total amount of data retrieved for the products to a subset of products that may be relevant to the user in the present or in the future, depending on the implementation. For instance, the matching and personalization engine 108 may query a database or a server 112 or 118 of a financial institution or third party for products, product information, product parameters, etc., relevant to users with a credit score in a given range. The products may further be narrowed or matched to the user, as discussed below.

At 310, the matching and personalization engine 108 may determine whether the user score satisfies one or more classification thresholds. For instance, the user may be classified into one of two or more categories or buckets, which buckets may affect an experience of the user in the graphical user interface. For instance, the matching and personalization engine 108 may modify graphical user interfaces, displayed or available buttons in graphical user interfaces, information presented, or products matched with the user based on the category or bucket into which the user's persona or attribute is classified.

In some implementations where the score includes a credit score, the user may be classified based on threshold credit score levels into one or more buckets (e.g., good credit or poor credit). In some instances, the classification may use one or more of the user attributes, scores, or other features reflected in their digital persona.

In some implementations, the matching and personalization engine 108 may first match the user (e.g., their attributes) against available products (e.g., the parameters) and, based on the quantity or types of products matched, may classify the user. For example, regardless of the user's credit score, if no products are matched, the user may be classified into a first bucket (e.g., unmatched or poor credit). In this way or others, the thresholds may be quantitative, qualitative, multi-dimensional, and/or dynamic.

For example, if the matching and personalization engine 108 determines that the user does not satisfy a first classification threshold, at 312, the matching and personalization engine 108 may determine user-specific guidance for improving the user score and/or qualifications for product(s) based on the determined user attribute(s), score, product parameters, and/or other guidance information. For instance, the matching and personalization engine 108 may compare one or more of the user's attributes against one or more parameters of the products, which may allow it to detect full, partial, or non matches for one or multiple products.

At 314, the matching and personalization engine 108 may generate a customized dashboard for user and/or institution including one or more graphical user interfaces for providing user-specific guidance.

For example, if the user is classified into a no-match, few matches, or poor credit category/bucket, the matching and personalization engine 108 may determine a first logical path for the user, and it may accordingly customize graphical user interfaces to the user. For example, based on the matching and personalization engine 108 determining that no or insufficient matches are made with the user (e.g., that the user's attributes do not satisfy the product parameters or that the score(s) is/are too low), it may match the user with guidance for improving the matches.

For example, the determined guidance may be generic guidance (e.g., textual, audio, video, graphical, etc., information) provided to users depending on their classification, scores, or attributes. In some implementations, various guidance may include parameters that may be matched to users' attributes in order to customize the guidance provided via the matching and personalization engine 108. In some implementations, computer learning may be used, for example, where a supervised learning model is trained by inputting user attributes that result in many matches, good matches, a certain match, etc. Additionally, or alternatively, the matching and personalization engine 108 may interface with one or more large language artificial intelligence models (LLMs) running locally or via an application programming interface. The LLMs may be provided by third-party servers 118 and may be fine-tuned or trained using the data of other users and guidance that proved (e.g., by supervised learning) effective in helping those other users' scores or attributes. In some cases, the LLMs may generate text, audio, video, etc., that explains to the user how to improve the user's attributes or scores relative to the possible products. The matching and personalization engine 108 may use retrieval augmented generation to allow LLM access and use of the user's persona/attributes and the attributes/parameters of matched, unmatched, or matchable products.

Accordingly, the matching and personalization engine 108 may determine which attributes are most likely to result in better scores or matches and/or which attributes for a given user would result in the most significant improvements.

In some implementations, the matching and personalization engine 108 may generate one or more dashboards with customized matches, guidance, or other information for the user and/or for the institution (e.g., as determined based on an institution server 112 via which the matching and personalization engine 108 was being accessed). For example, it may display, in a graphical user interface, an indication of which attributes/scores in their persona narrowed (e.g., disqualified) the most matches or resulted in their classification. In some cases, the graphical dashboard may inform a user which of their attributes (e.g., of their credit score) may be causing them to have poor credit, and/or it may display the next steps on their path toward pre-qualification or matching against some, all, or a specific product(s).

As noted below, the matching and personalization engine 108 may determine and present on the graphical user interfaces/dashboard credit score goals, credit building offers (e.g., higher interest rate or lower spending limit credit cards), expert advice, or other guidance or offers.

In some implementations, the matching and personalization engine 108 may determine, generate, and/or customize an action plan for the user based on their attributes, product parameters, user classification, or other criteria. For example, the guidance (e.g., as noted above) may include a series of steps to improve the user's scores/attributes/matches. Multiple steps or details may be determined for a single attribute or score, or each attribute or score may have a step or guidance. Other implementations are possible and contemplated herein.

In some implementations, if the matching and personalization engine 108 determines that the user does satisfy a first classification threshold (e.g., for a single product, for multiple products, for a single parameter, for a tier of a parameter, for multiple parameters, or otherwise) determined at 310, at 316, the matching and personalization engine 108 may determine one or more matching products based on user attribute(s) of the identified user and product parameter(s) of one or more products. For instance, as noted above, it may match received/retrieved user attributes with retrieved/received product attributes/parameters to determine products. In some cases, the matching and personalization engine 108 may retrieve additional product or feature functionality or details for each matched product either automatically or based on a user selection to display additional information in the graphical user interface.

At 318, the matching and personalization engine 108 may generate a customized dashboard for the user and/or institution including one or more graphical user interfaces for providing product information for the matched product(s) and/or user-specific guidance.

As described elsewhere herein, the generated interface(s) may present a set of offers to a user (e.g., a good score user may see instant, pre-qualified offers). Users may select from multiple kinds of pre-qualified offers and apply within the matching and personalization engine 108 interfaces (e.g., for auto, personal, and credit cards). The matching and personalization engine 108 may display details of a specific offer and may retrieve or display an application form/elements.

For instance, as noted elsewhere herein, the matching and personalization engine 108 may determine which products include parameters satisfied by the user's attributes, and the matching and personalization engine 108 may display corresponding information describing the products.

The matching and personalization engine 108 and or continuous qualification module 228 may automatically periodically refresh information on the dashboard or may refresh it upon request by the user, so that it can quickly keep the users informed of their attributes, matches, or other data, such as pre-qualification status, credit score, debt-to-income ratio, or their immediate action plan.

For instance, the action plan may include dynamic customized guidance information that is updated with user attributes, product parameters, guidance, etc., to focus the user on actions that will help them get better offers and/or improve their financial health. The action plan and its guidance or steps may be determined based on the persona (e.g., based on a credit report, self-reported data, institution server 112 account information, etc.). Accordingly, the action plan and matching and personalization engine 108 may improve product offers and help users make improvements to their financial health.

Whether in the interfaces displayed at 314 or 318 (or 324 or other operations), the interfaces may be displayed (or updated, as noted below) to allow goal tracking, such as where a user sets a goal for a credit score and a second goal for a timeline to accomplish it, or the user may set a goal for a product attribute to match (e.g., a payment, interest rate, level of product feature, tool, etc.). The matching and personalization engine 108 may access a database to retrieve or generate recommendations on how a user can improve their credit score and tracks the steps they take along their path to improvement may use the goals.

In some implementations, along with goal tracking, the matching and personalization engine 108 may provide a score simulator that allows users try different “what if” scenarios, for example, to see how changes they make in their use of credit could potentially impact their credit score. For example, in the financial institution example implementation, the user may experiment with changing a loan type, changing a loan amount, increasing or decreasing, increasing or decreasing credit limit, paying down balance, paying off balances, or other scenarios. The matching and personalization engine 108 may provide a debt-to-income (DTI) tool that allows users to see their current DTI ratio and learn how to make improvements, which may be an effective part of pre-qualification or product matching. As noted above, the matching and personalization engine 108 may gather information from different accounts with other institution servers 112, such as with other banks.

Various details of these operations are shown and displayed in reference to the example graphical user interfaces below.

In some implementations, at 320, the matching and personalization engine 108 may determine one or more alerts that identify a user attribute or product information/parameter change or combination thereof, which may affect a user to product/attribute/tool match. For instance, the matching and personalization engine 108 may receive user, stakeholder, or administrative settings or preferences indicating which alerts to send; match, attribute, or parameter change thresholds; user or product data refresh periods, or other information.

Depending on the implementation, the matching and personalization engine 108 may select, based on user preferences or another factor, one or more notification means, such as automatically transmitting an e-mail, text message, push notification, update to the dashboard and/or offers interface(s), or another available method of communication. Accordingly, the matching and personalization engine 108 may proactively contact users without further action by the user. Additionally, or alternatively, the alerts or other notifications may be determined and/or transmitted/shown to the user when the user logs into the dashboard.

In some implementations, the alerts may have an associated deviation percentage for which an inexact match may be made. For instance, if a match is close or an alert threshold is within a defined percentage or quantity, the matching and personalization engine 108 may notify the user that they are close to a match. In some instances, the matching and personalization engine 108 may also provide guidance indicating next steps to reach the match. In some cases, in order to be identified a match, the continuous qualification module 228 may determine that a match threshold is exceeded by a defined percentage prior to sending a notification. In some cases, a percent match may be determined, such as where a user has a value of a certain attribute, but the product parameter (or tier thereof) requires a different value. The matching and personalization engine 108 may determine a percent of the user attribute against the required value. Some example implementations are illustrated in reference to the example graphical interfaces herein, such as where a user's debt-to-income ratio is off by a certain percentage, number of points, or is a certain percentage of a required amount, etc. For example, the matching and personalization engine 108 may determine and/or display a proximity between a value of a certain user attribute and a value required by one or more tiers and/or product parameters, whether as a percentage, absolute value, or otherwise.

For example, the matching and personalization engine 108 may be configured to update data each minute, hour, day, week, month, or at another period or based on another trigger, such as a user's request to view the dashboard. Some attributes, parameters, guidance, action plans, or other data may be updated at varying periods or responsive to different triggers. An institution server 112 administrator or a user may set the refresh periods, alert preferences, or other settings.

In some implementations, at 322, the matching and personalization engine 108 (e.g., the continuous qualification module 228) may, periodically (e.g., with a defined, determined, or default periodicity/frequency period), query one or more first-party servers (e.g., 112 or 122) and/or third-party server(s) (e.g., 112 or 118). The matching and personalization engine 108 may process data received from the server(s) to detect changes and, if the changes satisfy the preferences, may trigger an alert to the user or otherwise update the graphical dashboard displayed/displayable to the user. The frequency/periodicity at which the data is monitored or updated may be based on how frequently the data is received from third-party server(s) 118, and/or it may be a defined period, such as every second, minute, thirty minutes, hourly, daily, weekly, etc., depending on a user or administrator definition.

The matching and personalization engine 108 (e.g., the continuous qualification module 228) may monitor rates and other offers, detect changes in rates or payments (or other terms) and notify the user when there has been a change. The matching and personalization engine 108 may determine monitoring preferences, such as where it receives an input in which a user can set monitoring for types of loans, frequencies, credit monitoring, etc., as noted elsewhere herein. In some instances, if a user does not like a rate or terms offered for matched products, they may set a goal or trigger term (e.g., varying a term that the user does not like or does not qualify for), which, when detected (e.g., the requested rate/term is satisfied) by the matching and personalization engine 108, may cause an alert or notification to be sent to the user. For example, when a user's attributes or a product's parameters change, such that the user is matched with a product with a requested feature, an alert may be triggered.

In some implementations, the matching and personalization engine 108 (e.g., the continuous qualification module 228) may refresh some or all of the data, for example, by repeating or updating one or more of the operations in steps 302-320. For instance, the user attributes or classification may change, products may be updated, or other changes may occur. The matching and personalization engine 108 may automatically perform the update(s) in the background without input from the user or another party. Accordingly, it may update the data to determine alerts without further user action.

At 324, the matching and personalization engine 108 may update the user's dashboard using the updated information and provide the updated graphical dashboard to user, for example, responsive to a request for the information or dashboard from a client device 106 of the user. For example, where the data noted above is refreshed every twenty-four hours, the matching and personalization engine 108 may serve a version of the dashboard that has data or matches aged less than twenty-four hours, so the dashboard is provided on demand.

As noted above, the tool provided by the matching and personalization engine 108 may provide and/or update education to the user about their credit score and the varied factors that contribute to their current rating with suggestions on things they can improve or change. For example, a user may affect the user attributes or wait for the product parameters to change to create a match or satisfy a target or alert. Similarly, the analytics, grades, graphs, scores, ratings, payment history, credit usage, account mix, inquiries, or other data may be updated. Any of the graphical interfaces described herein may be updated or others may be displayed as part of this process.

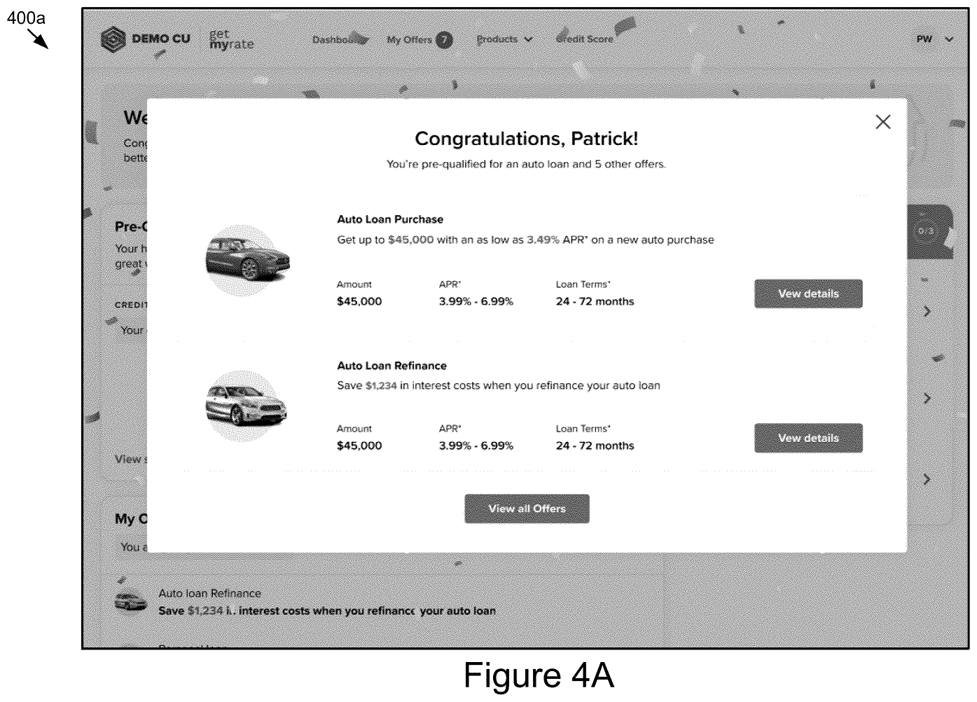

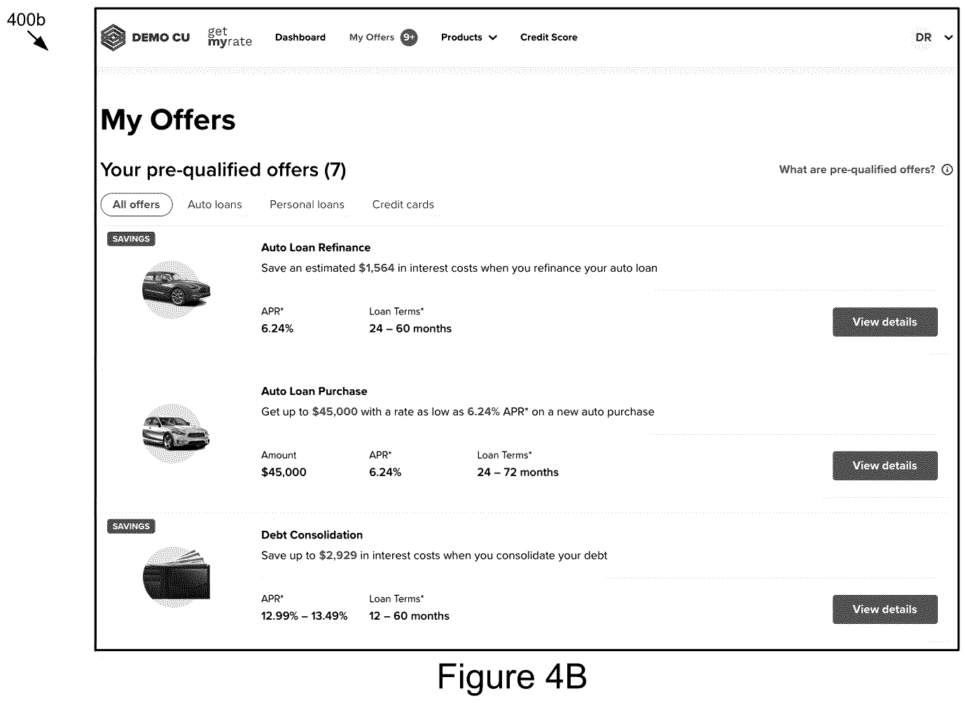

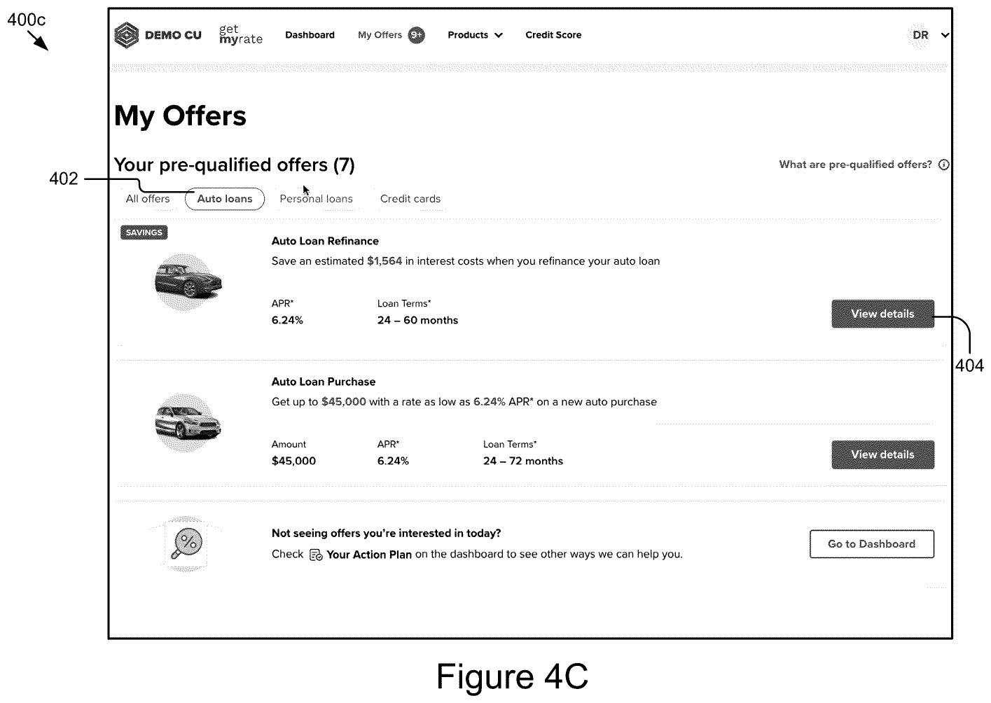

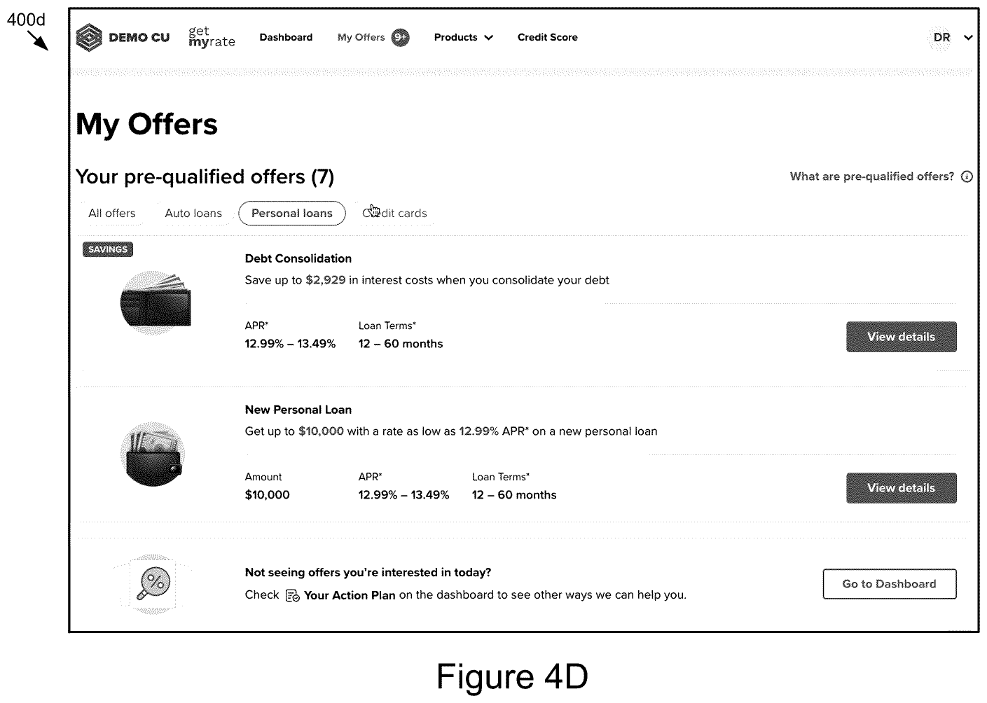

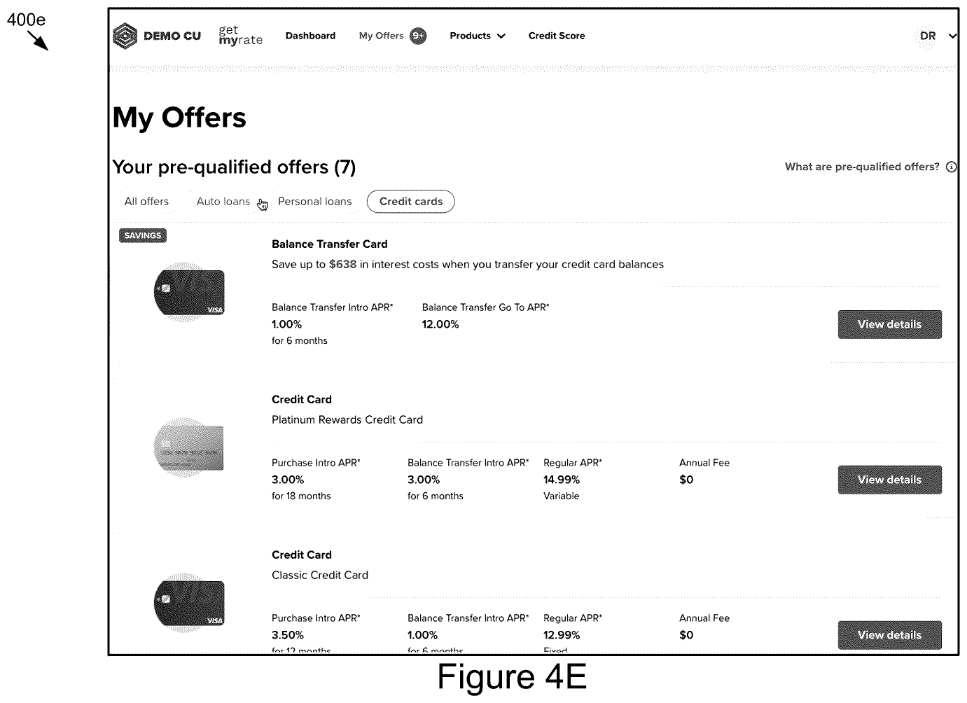

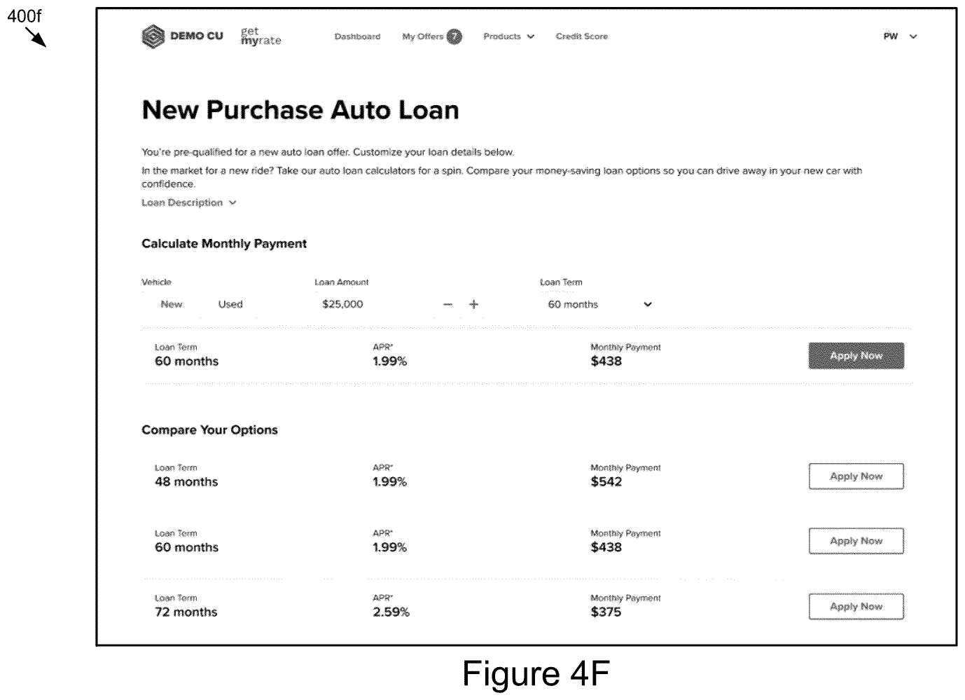

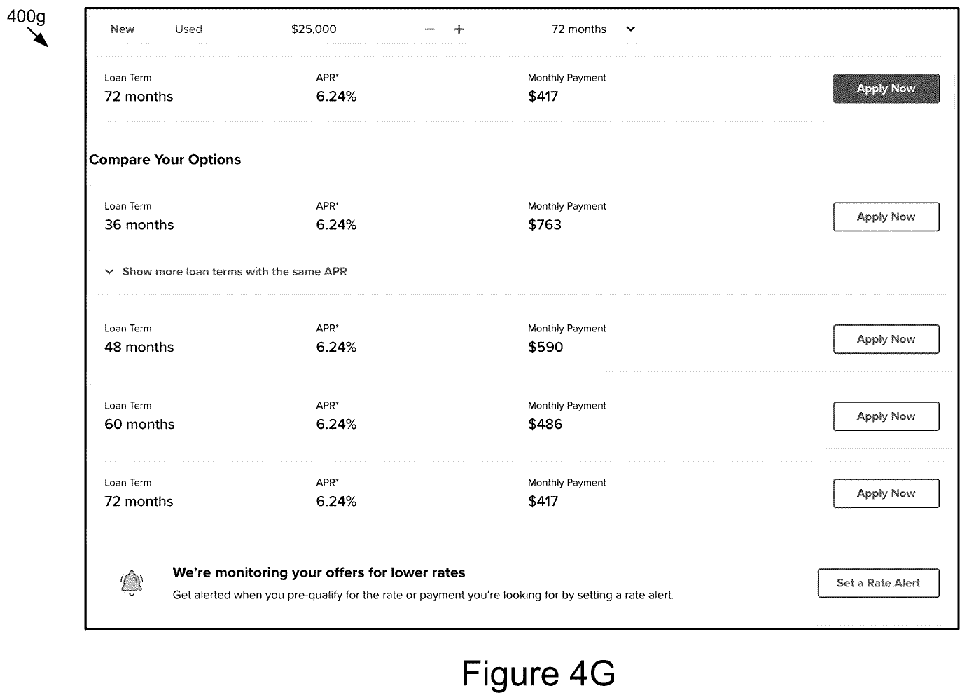

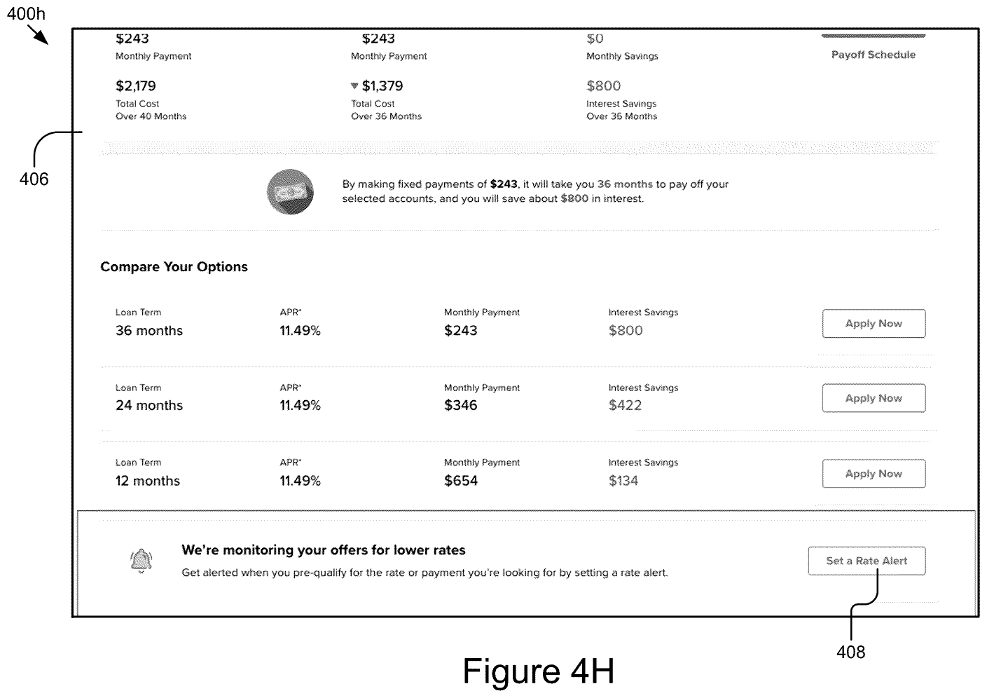

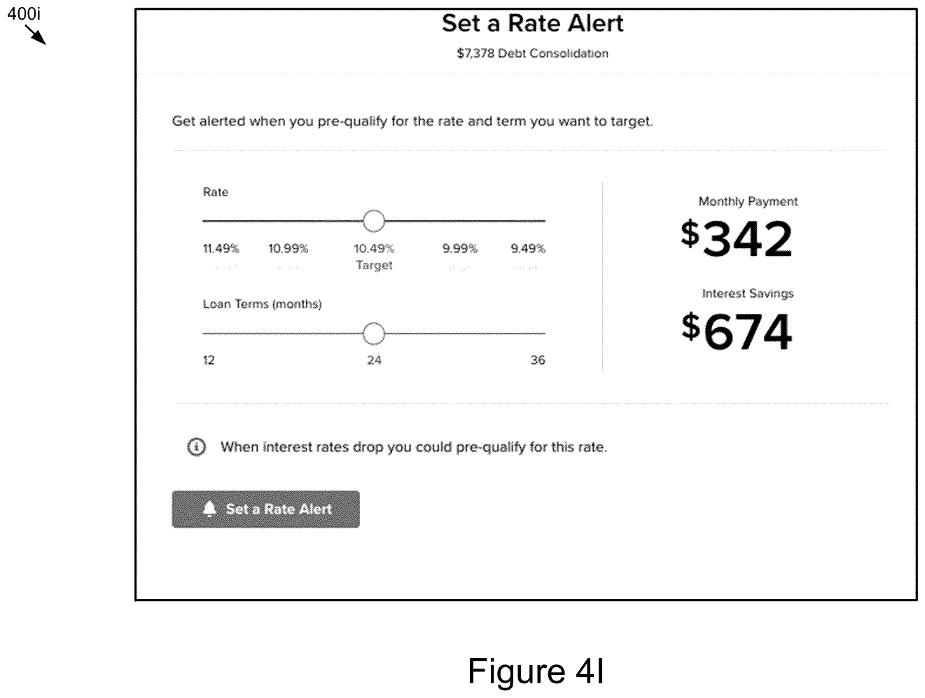

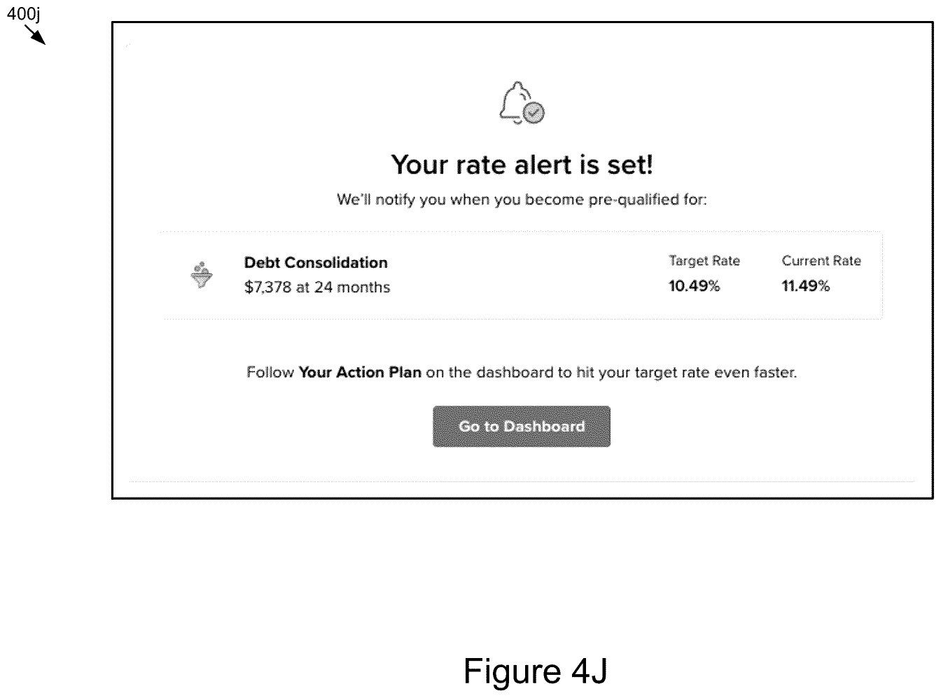

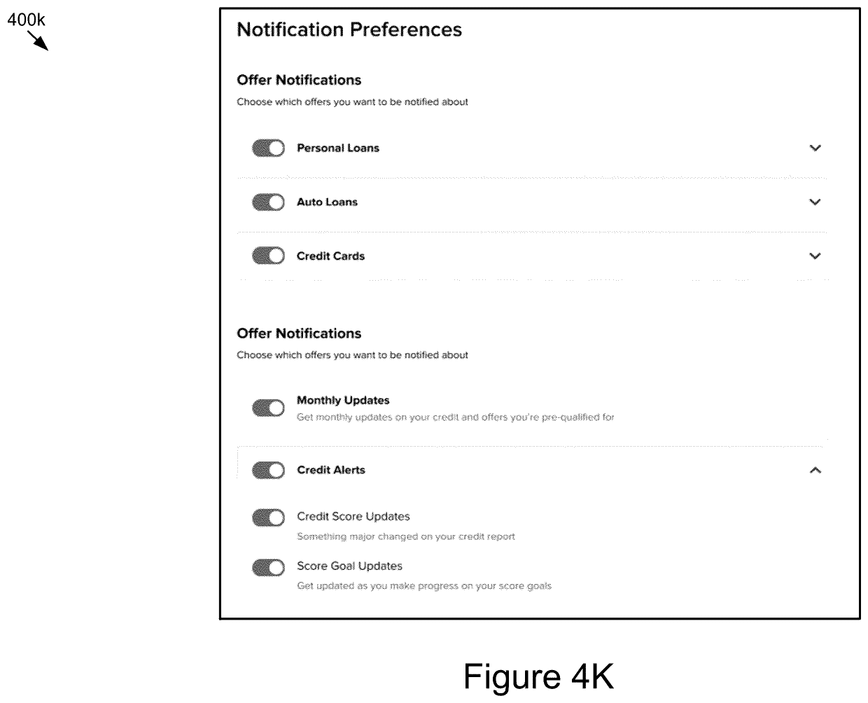

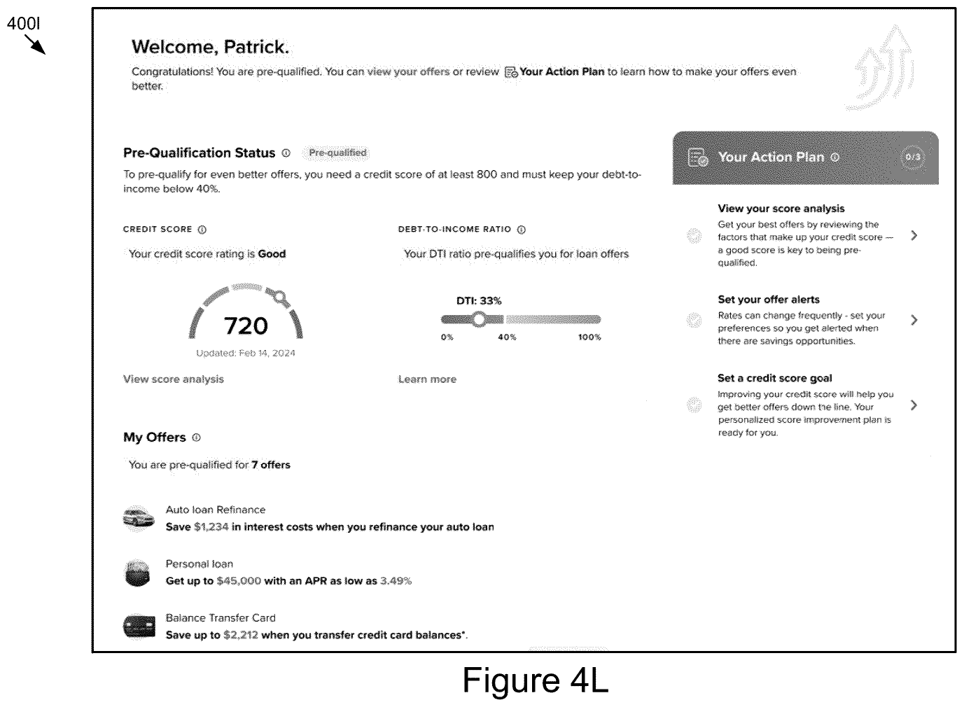

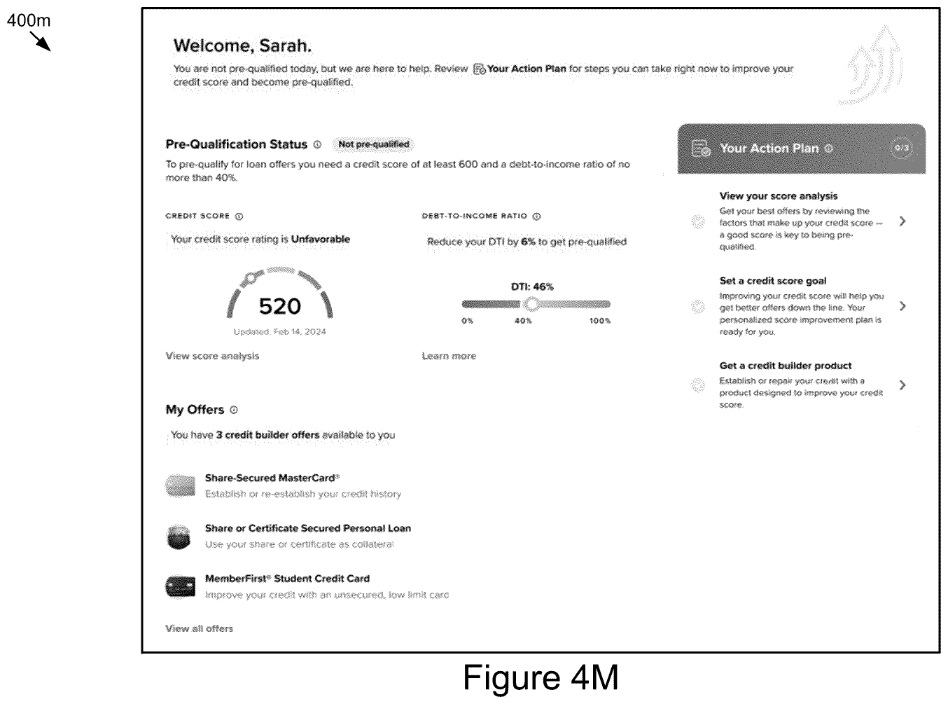

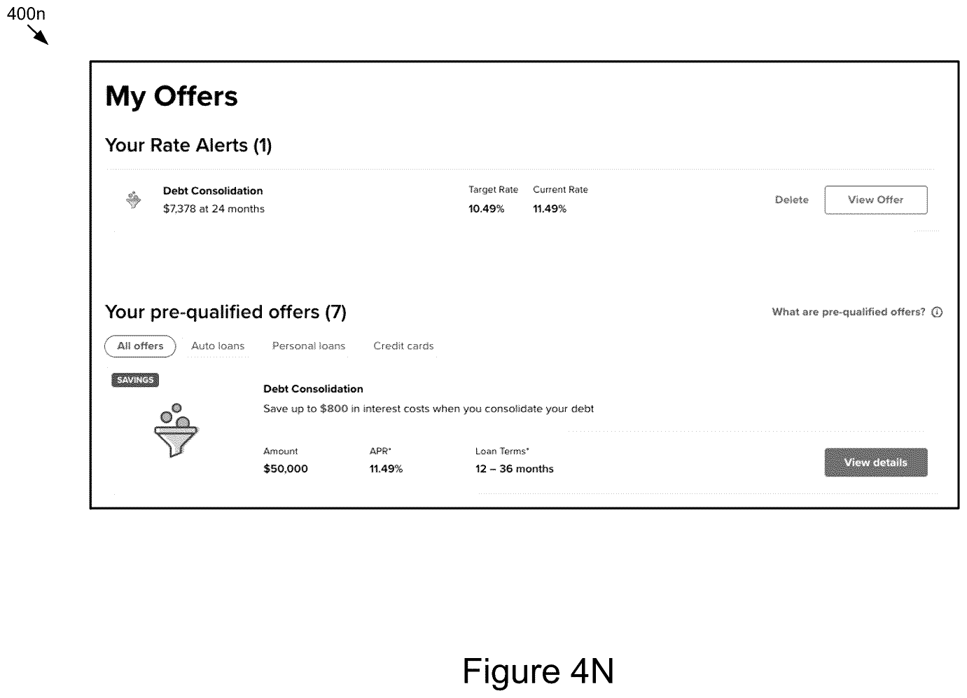

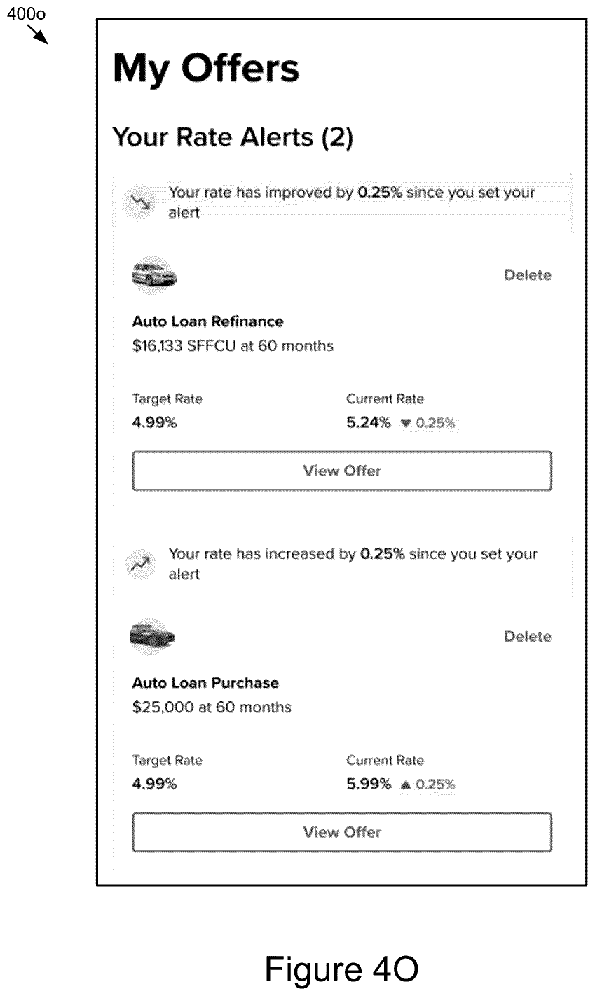

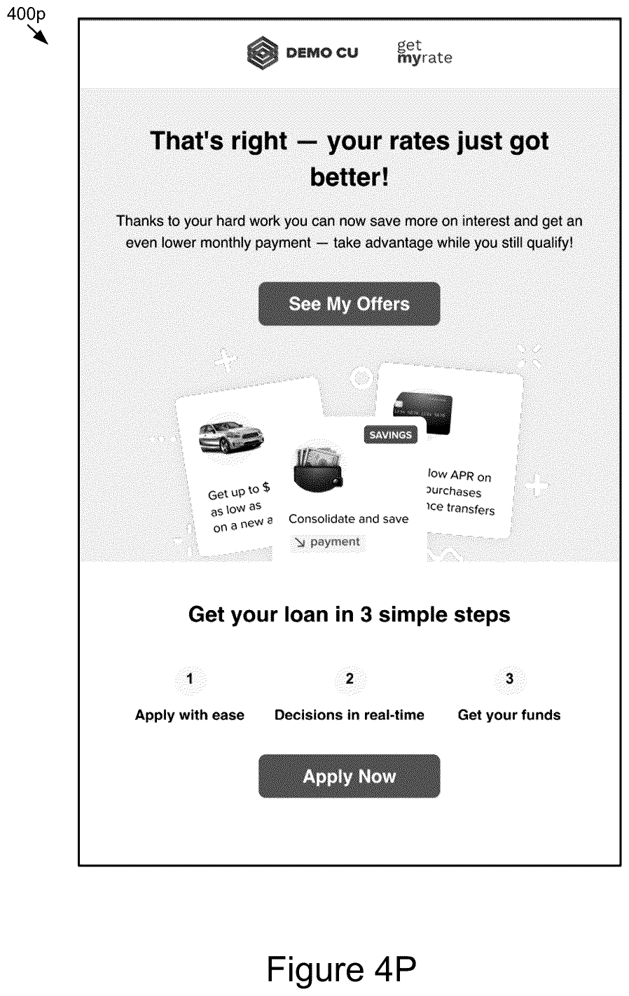

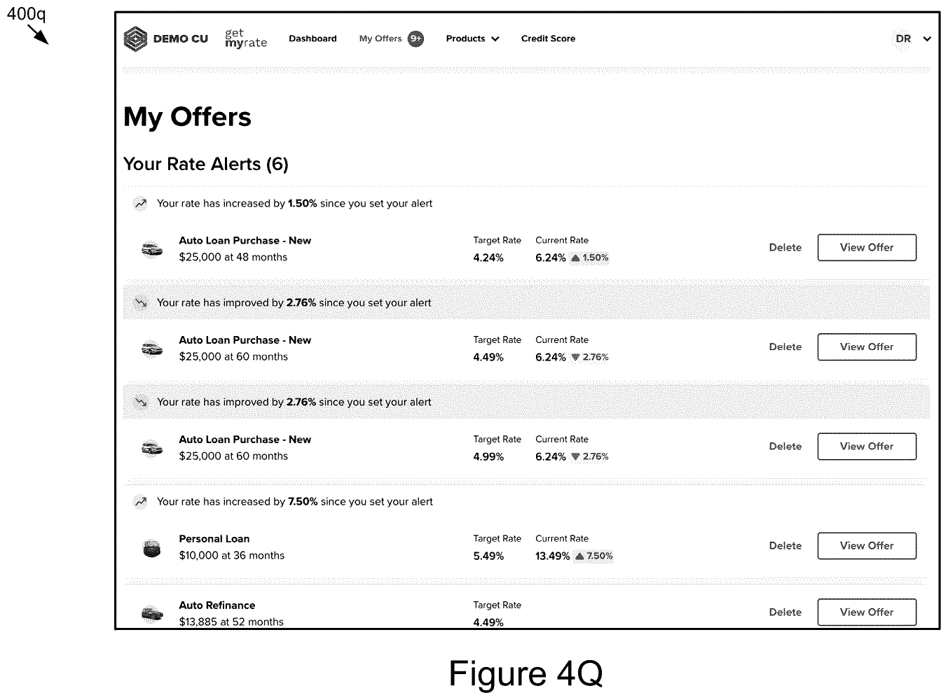

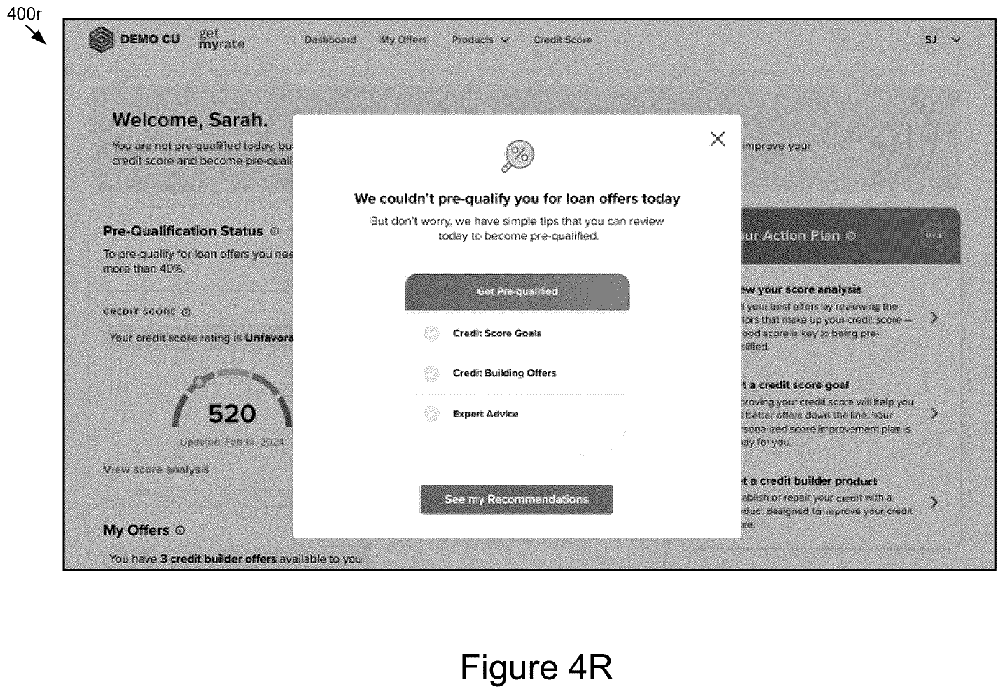

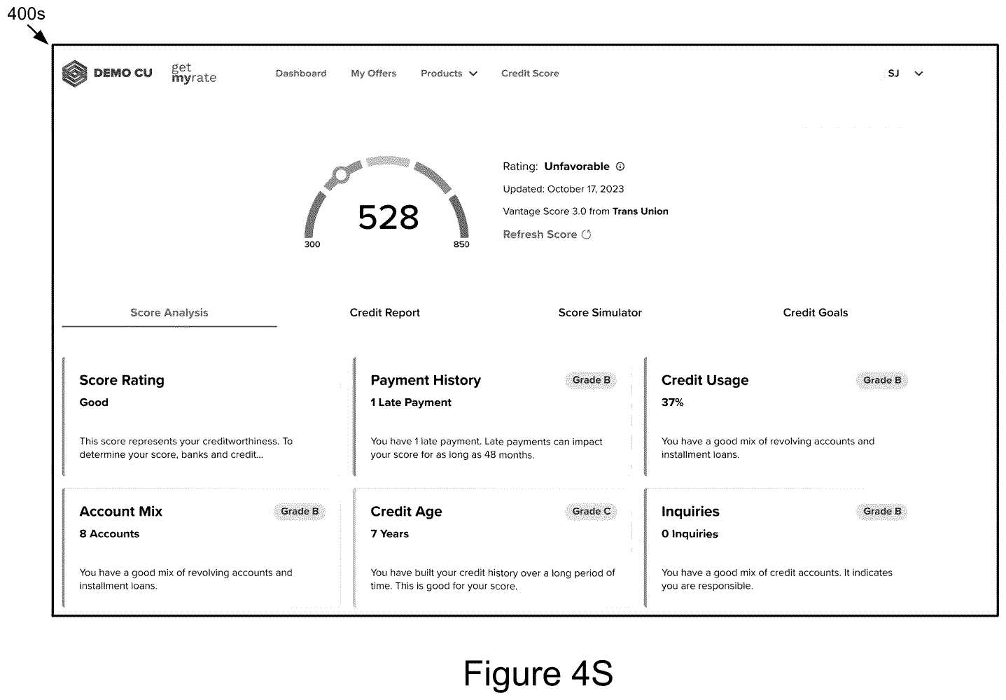

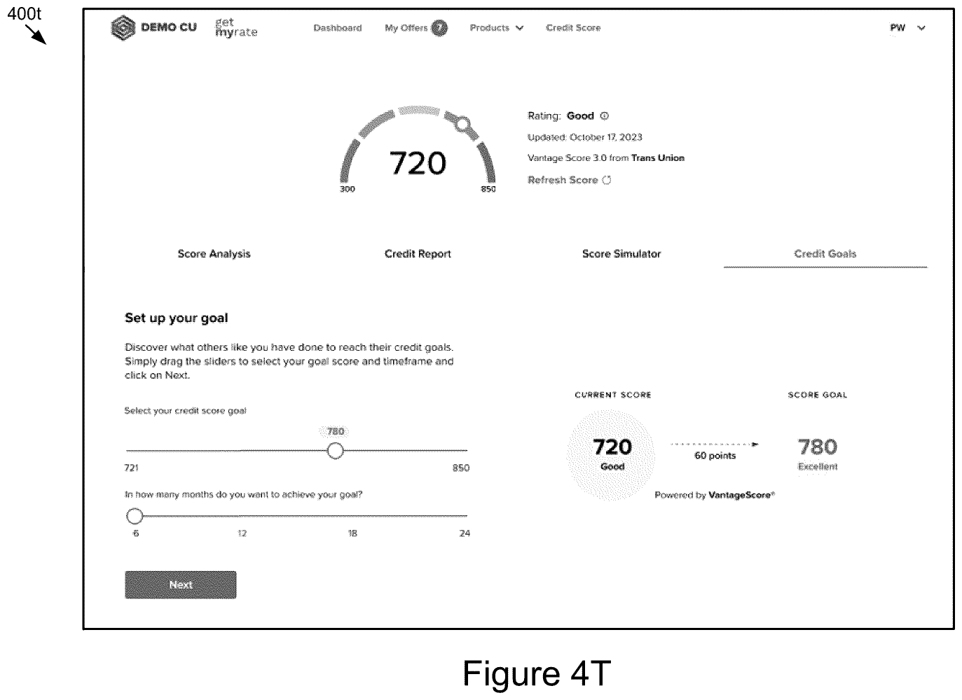

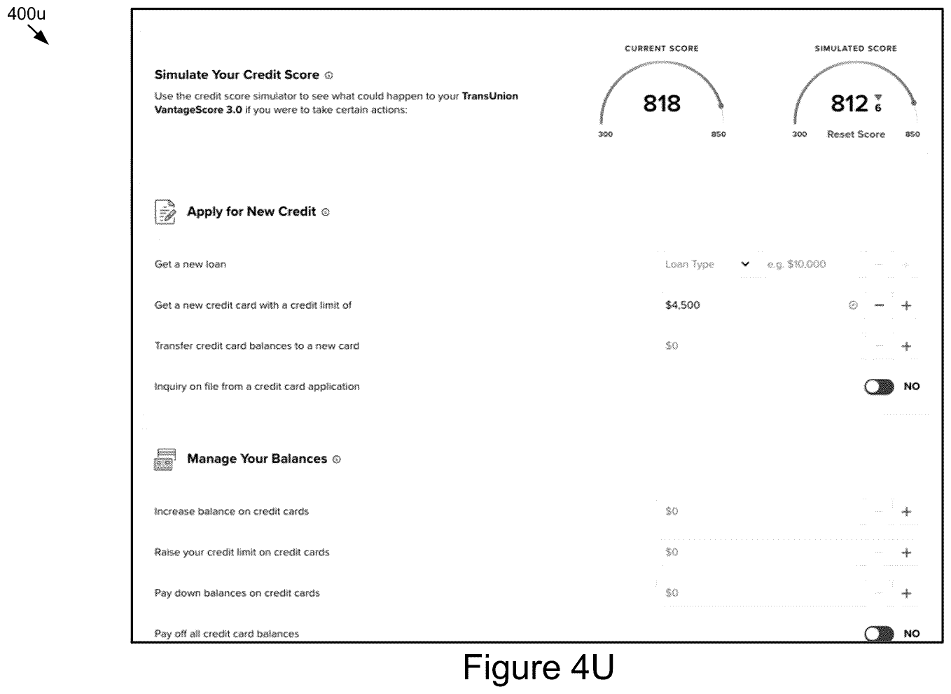

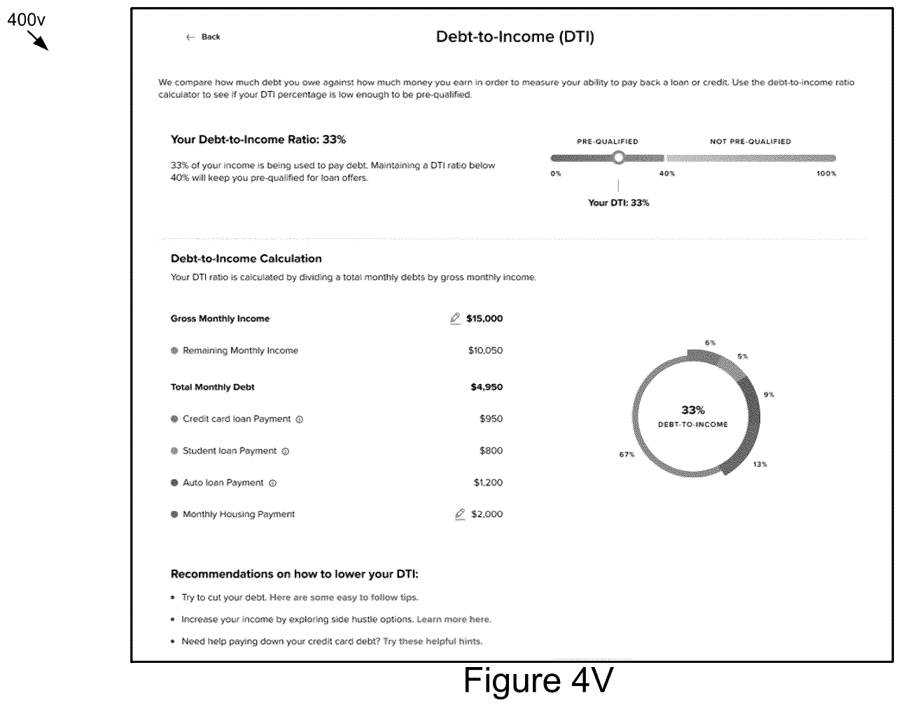

FIG. 4A illustrates an example graphical user interface 400a in which the matching and personalization engine 108 may display an indication of one or more product matches (e.g., loans for which the user is prequalified). The matching and personalization engine 108, responsive to user inputs, may display information for each product or additional products. For instance, if the user is matched with one or more products, the matching and personalization engine 108 may generate a graphical overlay displaying a full or partial list of offers (e.g., limited to two or three of the best offers) along with a subset of details and graphical buttons to display additional details, use, and/or apply for the product.

FIG. 4B illustrates an example graphical user interface 400b in which the matching and personalization engine 108 may display a filterable list of product matches. The matching and personalization engine 108 may automatically determine and display product information, such as loan terms, interest rates, or other information based on the match(es). In the depicted example interface 400b, the matching and personalization engine 108 may determine matches and retrieve a subset of data for all or some matches and serve it to the user. As shown in the example, while the user believes that s/he is interacting with the website of their bank or another institution, the matching and personalization engine 108 may provide functionality from one or more other servers 112, 118, and/or 122, so that the user does not need to navigate to the other websites to find and research, manually identify matches, research options, and find details. Not only does this scenario present inconvenience and security/privacy issues, but it also causes significant bandwidth usage by the client device 106 and/or other servers. The present implementation, by adapting information from various sources to a user and/or institution server 112, may more quickly, accurately, and efficiently retrieve the relevant portions of user and/or product data. Once the user or matching and personalization engine 108 has determined a particular product/feature, the matching and personalization engine 108 may automatically retrieve the remaining relevant information to the user. This prevents data security gaps by allowing secure backend communication directly with secure servers and also limits retrieval of unnecessary information.

Additionally, as noted elsewhere herein, the continuous qualification module 228 may, on the backend/server without further user interaction, periodically retrieve and/or continuously retrieve/receive user and product data in order to update matches. Accordingly, using the continuous monitoring, the matching and personalization engine 108 may update the user on their currently approved products, features, tools, etc. It may also automatically track progress of the user's attributes and product parameters toward each other.

As noted elsewhere herein, when the user logs in to the institution server's 112 website and/or selects a link for the matching and personalization engine 108, the matching and personalization engine 108 may communicate with the institution server's 112 website to determine user attributes, such as their name, birthdate, credit score, spending patterns, income, or other attributes, which could be augmented using third-party data, to identify matches.

In some implementations, when the user logs into a website for the institution server 112 and/or for the application server 122, the matching and personalization engine 108 may automatically determine current matches and then display them in the example interface 400b. If there are more matches than may be displayed on a client device 106 based on the identification of the type or resolution of the client device 106, the interface 400b may include multiple pages, may be scrollable, or may automatically reduce or filter the quantity of displayed matches to match the resolution, aspect ratio, or type.

As illustrated in FIGS. 4C, 4D, and 4E in the example interfaces 400c, 400d, and 400e, the matching and personalization engine 108 may provide graphical elements that allow the user to quickly filter the matched and/or unmatched products. In the illustrated examples For instance, the matching and personalization engine 108 may automatically group the products based on their type or certain other attributes and provide graphical elements (e.g., 402) indicating each of the groupings, which element(s) may be selectable to filter the set of matches. For example, each offer and/or grouping of offers may relate to a certain product type, such as a loan, type of loan (e.g., auto, credit card, mortgage, etc.) or otherwise. For example, each offer may correspond to a type (e.g., an auto loan purchase, auto loan refinance, credit card) and/or to a product from various sources (e.g., a mortgage from company A, a mortgage from company B, etc.). In some implementations, the filtering elements may be automatically generated or displayed based on the set of matches, so that unnecessary filters may not be displayed, or a customized set are displayed. These filtering elements may be used in place of or in addition to more traditional filtering elements, such as a search field or dropdown menu.

FIG. 4F illustrates an example graphical user interface 400f in which the matching and personalization engine 108 may display products, such as loan offers, and FIG. 4G illustrates an example graphical user interface 400g, which may be a scrolled down or second page to the example interface 400f. For instance, the user may filter the offers based on the types of products in which the user is interested. The user may use the matching and personalization engine 108 to apply for the loans, use the matched software features or tools, or otherwise interact with the product(s). In some implementations, the matching and personalization engine 108 may also allow interaction with the institution server 112, application server 122, and/or third-party server 118 to interact with (e.g., apply for) the products (e.g., via APIs, iframes, or links).

The example interface 400f may be displayed in response to the user selecting to view details on an offer, product, or group thereof. For instance, a user selects to view details in graphical element 404 of FIG. 4C, the matching and personalization engine 108 automatically retrieve details of matching products and calculate their details for the user. FIG. 4F may display various options for that offer/product, such as various loan terms, percentage rates, or other details. For example, the example interface 400f may show a calculator in which the user may select certain terms (e.g., loan amount, term, type, etc.), and which may be automatically customized to the user, such as based on the offers for which the user qualifies (e.g., a user with a good score may qualify for a more favorable rate and therefore lower payments or a higher limit, though other risk tiers, feature access tiers, etc., are possible).

FIG. 4H illustrates an example interface 400h, which may represent a detailed view for a particular offer. For instance, the example interface 400h may represent an alternative to the example interface 400f or 400g. As shown, a graphical element or area 406 displaying current products for which the user is enrolled or which may be changed (e.g., in an updated offer/product). In this example, one or more of the user's current products, features, or tools may be displayed adjacent to new products/offers, for example, where revisions may be calculated.

As illustrated in FIG. 4H (as well as elsewhere herein), the interface 400h may display a call-to-action graphical element 408 that the user may select to set a rate alert, initiate monitoring, view monitoring, or view alerts. For example, on the details page of a specific offer, the matching and personalization engine 108 may provide the opportunity to set a rate alert, which monitors rates on an on-going basis and lets the user know via email (or other notification) and/or a dashboard display when they are eligible for their target rate that they previously set.

FIG. 4I illustrates an example interface 400i in which a user may select parameters of an alert. While the example of adjusting target terms of a loan product, other implementations, such as computing speed, model accuracy, bandwidth usage, or other terms may be set as target terms. For instance, underlying calculations (e.g., by the continuous qualification module 228) may be based on the user attributes and/or product parameters, such as where a product parameter, for which the user is setting an alert, allows a user with a certain credit rating, income, and/or other attribute may satisfy that parameter. The product may have a set of parameters that indicate various terms, so that a user that satisfies a first parameter may match a term for that satisfied parameter. In some cases, the user may provide requested terms and the continuous qualification module 228 may check the user's attributes against parameters of products in order to detect a match that provides the target term(s). Either the parameter or the user attribute may change to allow it to be satisfied.

In the depicted example, when the user selects to set a rate alert (e.g., via element 408), the matching and personalization engine 108 may display the example interface 400i in which they can select, via one or more sliders terms, such as annual percentage rates, loan length, payment, or otherwise. The matching and personalization engine 108 or continuous qualification engine may automatically calculate the monthly payment savings, or other computations relative to the terms for which the user is currently qualified and/or to which other term targets defined by the user.

In some cases, the matching and personalization engine 108 may determine a proximity or difference between the user attribute(s) (or product parameter(s)) and the attribute required to satisfy the match for the target terms, such as improvement in the user's credit score. The proximity may be a percentage, numerical value, or otherwise. The matching and personalization engine 108 may display a graphical indication in text, an automatically generated chart, animation, or other graphical feature to indicate an improvement the user could make to satisfy the match. Accordingly, a user may set a target, see the benefit of the target, and see the changes needed to achieve the target.

In some implementations, the continuous qualification module 228 may then specifically identify the user attributes and product parameters and terms that would change to satisfy a match. The continuous qualification module 228 may monitor only those attributes/parameters needed for a change in order to reduce used processing cycles or bandwidth. In some implementations, once the match has been satisfied for the monitored subset of attributes, parameters, etc., the continuous qualification module 228 may confirm that the remaining attributes and parameters match (e.g., to ensure that those aspects have not changed negating the match). Accordingly, these processes are significantly more efficient than systems in which all attributes or parameters are checked, thereby allowing more efficient, frequent, or continuous monitoring in the background. These benefits are compounded when a user has multiple alerts for multiple products and when an institution server 112 and/or application server 122 performs these operations across tens, hundreds, thousands, or even millions of users. Furthermore, these benefits are again compounded when user attributes and product details/parameters are received or retrieved from multiple or many servers.

FIG. 4J illustrates an example graphical user interface 400j in which a confirmation of the alert and its terms, for instance, are displayed to the user.

FIG. 4K illustrates an example graphical user interface 400k in which a user may define notification preferences, for example, for the alert. In the example, the interface includes switches or toggles allowing the user to select from their defined alerts, select alert types, notification frequency, credit score or other user attribute changes, product parameter changes, or otherwise. In some cases, the example interface 400k may additionally or alternatively allow the user to indicate notification means, such as via a dashboard, push notification, email, text message, and so forth.

For instance, FIG. 4K illustrates an example graphical user interface 400k in which the matching and personalization engine 108 may display products, such as loan offers. The user may indicate for which product matches they would like to be notified, how frequently they would be notified (and/or a refresh period), types of updates, or other information. For example, the matching and personalization engine 108 may set alerts for when offers improve, allow a user to track progress over multiple sessions, or access credit-improvement tools.

FIG. 4L illustrates an example graphical user interface 400l in which the matching and personalization engine 108 may display a dashboard including information and offers respective to the user. As noted elsewhere herein, the dashboard may be customized based on the user, user classification, institution (e.g., the institution server 112 via which it is accessed or with which it is associated), matches, guidance, or other criteria. For example, the example interface 400l may display a credit score, debt-to-income ratio, action plan, and/or product matches or offers.

The example dashboard may be customized to the user, their attributes, their matched products, etc. In some implementations, it may include boxes, containers, frames, or other divisions. In the depicted example of FIG. 4L, the matching and personalization engine 108 may display the user's pre-qualification status, credit score, DTI, current offers/matches, near offers/matches, alerts, or other details. In some implementations, as noted elsewhere herein, the matching and personalization engine 108 may display guidance customized to the user respective to their attributes (e.g., thresholds thereof, matches, or otherwise) that indicate analysis, improvements, alerts, or other information.

FIG. 4M illustrates an example graphical user interface 400m, which may correspond to the interface of 400l, but where some of the data has been customized to a separate user. As illustrated in the example, the interface 400m may indicate that the user is not prequalified and note the changes that should happen to qualify for any or a specific offer/product. In the depicted example, the matching and personalization engine 108 may indicate that the user's credit rating is too low and/or a percentage by which they should reduce their DTI to qualify. Their offers, alerts, action plan/customized guidance, or other graphical elements may be customized to the user. FIG. 4M illustrates an example graphical user interface 400m or dashboard in which the matching and personalization engine 108 provides customized graphical elements and other information for a user and/or institution. For instance, the interface 400m may indicate a graphical depiction of a credit score, debt-to-income ratio, offers (e.g., products or guidance), an action plan, or other information.

FIG. 4N illustrates an example graphical user interface 400n, which may represent an additional or alternative dashboard page, or a page scrolled down from the other dashboard page (e.g., 400m) or displayed upon selection of a “view all offers” button. A rate alert may be prominently displayed. In some cases, there may be a rate alert for each or some of the offers in the system. For example, as illustrated in FIG. 4N, the user is pre-qualified for seven offers, which may have seven separate alerts.

FIG. 4O illustrates an example graphical user interface 400o, which the matching and personalization engine 108 may display as a mobile dashboard or based on client devices 106 with a different type, aspect ratio, or resolution. The user may view alerts or offers, review status or progress toward the targets, delete alerts, or otherwise manage them.

FIG. 4P illustrates an example graphical user interface 400p, which may represent a notification, such as a push notification or email displayed to a user when an alert is triggered, such as when a match is satisfied. For example, when the alert is satisfied, an alert notification may automatically be sent to a client device 106 associated with the user. The notification may display offers for the user and/or may allow the user to view offers, access functionality or tools (e.g., software tools, features, or documents), and/or apply for the offer(s).

FIG. 4Q illustrates an example graphical user interface 400q, which the matching and personalization engine 108 may display, for example, in response to selection of an option to view alerts or offers in a dashboard and/or in a notification. As illustrated in the example, the offers, matches, and/or alerts may be displayed with updated information for based on the monitored changes for the user and/or products.

Depending on the implementation, a graphical element, such as a frame or box may be displayed for each alert indicating a change in the user attribute or product, progress toward or past a goal, or other information. In some cases, the matching and personalization engine 108 may automatically provide access to the user to software features, tools, webpages, forms, or otherwise based on the match(es) being satisfied. For example, the matching and personalization engine 108 may unlock access to forms to apply for an offer (e.g., for which the user is pre-qualified). The matching and personalization engine 108 may automatically fill user attributes into the form or otherwise automate the application process.

FIG. 4R illustrates an example graphical user interface 400r, which may indicate a popup or overlayed window, which the matching and personalization engine 108 may display if a user does not qualify for any offers or for a particular offer. The user may select one or more elements that provide guidance information, which may be customized to the user. For example, FIG. 4R illustrates an example graphical user interface in which the matching and personalization engine 108 informs a user that no products were matched. The interface may allow the user to set goals (e.g., credit goals), see attribute-improving (e.g., credit-building) offers, or retrieve guidance or expert advice.

FIG. 4S illustrates an example graphical user interface 400s, which the matching and personalization engine 108 may display, for example, in response selection of a score analysis element (e.g., in the example of FIG. 4R or FIG. 4L). The matching and personalization engine 108 may display tabs for a score analysis, credit report, score simulator/calculator, credit goals, or other features. As shown in the example of FIG. 4S, the graphical cards may be shown with score rating, account mix, credit age, payment history, credit usage, inquiries, or other factors. This simplified interface may improve readability for the user.

For example, FIG. 4S illustrates an example graphical user interface 400s or dashboard in which the matching and personalization engine 108 may display guidance, an action plan, user attributes, or other data. For instance, the dashboard may display the user's credit score, credit usage, account mix, credit age, credit inquiries, etc. In some implementations, the elements displayed may be based on information retrieved from a third-party server 118, analytics, matches, or other data determined by the matching and personalization engine 108. As noted below, the information may be determined in real time or in response to the user request or may be periodically or continuously updated to track the user's attributes or matches.

FIG. 4T illustrates an example graphical user interface 400t, which the matching and personalization engine 108 may display, for example, in response selection of a credit goal tab (e.g., in the interface 400s). The credit goal tab may indicate current user attributes and/or goal user attributes (e.g., based on alerts set elsewhere), or other alerts or goals. The example graphical user interface 400t may allow the matching and personalization engine 108 to display credit improvement tools. For instance, the interface 400t may include sliders for setting a target credit score (or other attribute) and a number of months to reach that goal. Based on the goals, the matching and personalization engine 108 may match or otherwise determine guidance for achieving the goal, such as by reducing credit usage or changing account mix.

FIG. 4U illustrates an example graphical user interface 400u in which the matching and personalization engine 108 may display simulations or calculators that indicate, for instance, what changes in matches, scores, attributes, etc., may be made or their results. In some implementations, the simulators, calculators, or other features may be unlocked based on a match, as noted elsewhere herein, and/or may be automatically customized to the user, matched products, or the user's target terms. For instance, the matching and personalization engine 108 may display changes in matches, loan calculators, or other simulations or adjustments that allow a user to experiment with how changes in their attributes affect matched products, such as available interest rates, etc. A user may determine how a changed credit score, credit card balance, or other criteria would affect their score, their interest rates, or otherwise.

FIG. 4V illustrates an example graphical user interface 400v in which the matching and personalization engine 108 may display analytics or other attributes. In some instances, the analytics or other attributes may be displayed relative to a target or required parameter of a product. For instance, the interface 400v may display a debt-to-income ratio and a graph indicating how close the user is to qualifying for a product based on that attribute/ratio. In some implementations, the matching and personalization engine 108 may also display user attributes that form component parts of an aggregate attribute, such as each payment adding up to a total debt payment. The matching and personalization engine 108 may also display guidance for the user regarding how to improve that attribute or improve the attribute's match against a corresponding product parameter.

In the above description, for purposes of explanation, numerous specific details are set forth in order to provide a thorough understanding of the present disclosure. However, it should be understood that the technology described herein can be practiced without these specific details. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

To ease description, some elements of the system 100 and/or the methods are referred to using the labels first, second, third, etc. These labels are intended to help to distinguish the elements but do not necessarily imply any particular order or ranking unless indicated otherwise.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various implementations described herein may relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The technology described herein can take the form of an entirely hardware implementation, an entirely software implementation, or implementations containing both hardware and software elements. For instance, the technology may be implemented in software, which includes but is not limited to firmware, resident software, microcode, etc. Furthermore, the technology can take the form of a computer program product accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input or I/O devices (including but not limited to keyboards, displays, pointing devices, etc.) can be coupled to the system either directly or through intervening I/O controllers.

Network adapters may also be coupled to the system to enable the data processing system to become coupled to other data processing systems, storage devices, remote printers, etc., through intervening private and/or public networks. Wireless (e.g., Wi-Fi™) transceivers, Ethernet adapters, and Modems, are just a few examples of network adapters. The private and public networks may have any number of configurations and/or topologies. Data may be transmitted between these devices via the networks using a variety of different communication protocols including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), WebSocket (WS), wireless access protocol (WAP), various messaging protocols (SMS, MMS, XMS, IMAP, SMTP, POP, WebDAV, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. As will be understood by those familiar with the art, the specification may be embodied in other specific forms without departing from the spirit or essential characteristics thereof. Likewise, the particular naming and division of the modules, routines, features, attributes, methodologies, and other aspects are not mandatory or significant, and the mechanisms that implement the specification or its features may have different names, divisions and/or formats. Furthermore, the modules, routines, features, attributes, methodologies, and other aspects of the disclosure can be implemented as software, hardware, firmware, or any combination of the foregoing. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment.

What is claimed is:

1. A computer-implemented method comprising:
receiving, by one or more processors, user identification information;
determining, by the one or more processors, one or more user attributes based on the user identification information;
determining, by the one or more processors, one or more data sets describing one or more products, each of the one or more data sets including one or more product parameters, each of the one or more product parameters being associated with a user attribute;
determining, by the one or more processors, a set of matched products based on whether the one or more user attributes satisfy the one or more product parameters of the one or more products; and
providing, by the one or more processors to a client device, one or more graphical interfaces representing the set of matched products.

2. The computer-implemented method of claim 1, further comprising:
automatically updating, by the one or more processors, at least one of the one or more user attributes and the one or more product parameters; and
providing, by the one or more processors, the one or more graphical interfaces representing the automatically updated data to the client device.

3. The computer-implemented method of claim 2, wherein:
providing the one or more graphical interfaces representing the automatically updated data includes displaying a graphical element indicating a percent match between the one or more user attributes and the one or more product parameters.

4. The computer-implemented method of claim 2, further comprising:
determining, by the one or more processors, an updated set of matched products based on the automatically updated at least one of the one or more user attributes and the one or more product parameters; and
providing, by the one or more processors, the one or more graphical interfaces including graphically representing the automatically updated data on the client device.

5. The computer-implemented method of claim 4, wherein:
automatically updating the at least one of the one or more user attributes and the one or more product parameters includes automatically determining one or more changes to the one or more user attributes; and
determining the updated set of matched products includes detecting that the one or more user attributes matches a product parameter of an additional product of the one or more products.

6. The computer-implemented method of claim 1, further comprising:
automatically querying, by the one or more processors, one or more third-party servers to determine one or more of updated user attributes and updated product parameters; and
determining, by the one or more processors, one or more new matches from among the one or more products, the one or more new matches being separate from the set of matched products.

7. The computer-implemented method of claim 6, wherein:
automatically querying the one or more third-party servers is performed at a defined frequency period; and
providing the one or more graphical interfaces representing the set of matched products includes automatically providing a notification to the client device based on the one or more new matches.

8. The computer-implemented method of claim 1, comprising:
determining, by the one or more processors, a change to at least one of the one or more user attributes and the one or more product parameters;
automatically computing, by the one or more processors, a proximity of the one or more user attributes to the one or more product parameters; and
displaying, by the one or more processors, a graphical indication of the proximity in the one or more graphical interfaces.

9. The computer-implemented method of claim 8, further comprising:
determining, by the one or more processors, an alert respective to a particular product type of the one or more products, the alert indicating a target term for the particular product type;
determining, by the one or more processors, that the target term is satisfied based on the change to the at least one of the one or more user attributes and the one or more product parameters; and
displaying, by the one or more processors, a notification indicating the alert.

10. The computer-implemented method of claim 8, further comprising:
determining, by the one or more processors, guidance information based on the proximity of the one or more user attributes to the one or more product parameters; and
providing, by the one or more processors, the guidance information to the client device.

11. A system comprising:
one or more processors; and
one or more computer-readable memories storing instructions that, when executed by the one or more processors, causes the system to perform operations comprising;
receiving user identification information;
determining one or more user attributes based on the user identification information;
determining one or more data sets describing one or more products, each of the one or more data sets including one or more product parameters, each of the one or more product parameters being associated with a user attribute;
determining a set of matched products based on whether the one or more user attributes satisfy the one or more product parameters of the one or more products; and
providing, to a client device, one or more graphical interfaces representing the set of matched products.

12. The system of claim 11, wherein the operations further comprise:
automatically updating at least one of the one or more user attributes and the one or more product parameters; and
providing the one or more graphical interfaces representing the automatically updated data to the client device.

13. The system of claim 12, wherein:
providing the one or more graphical interfaces representing the automatically updated data includes displaying a graphical element indicating a percent match between the one or more user attributes and the one or more product parameters.

14. The system of claim 12, wherein the operations further comprise:
determining an updated set of matched products based on the automatically updated at least one of the one or more user attributes and the one or more product parameters; and
providing the one or more graphical interfaces including graphically representing the automatically updated data on the client device.

15. The system of claim 14, wherein:
automatically updating the at least one of the one or more user attributes and the one or more product parameters includes automatically determining one or more changes to the one or more user attributes; and
determining the updated set of matched products includes detecting that the one or more user attributes matches a product parameter of an additional product of the one or more products.

16. The system of claim 11, wherein the operations further comprise:
automatically querying one or more third-party servers to determine one or more of updated user attributes and updated product parameters; and
determining one or more new matches from among the one or more products, the one or more new matches being separate from the set of matched products.

17. The system of claim 16, wherein:
automatically querying the one or more third-party servers is performed at a defined frequency period; and
providing the one or more graphical interfaces representing the set of matched products includes automatically providing a notification to the client device based on the one or more new matches.

18. The system of claim 11, wherein the operations further comprise:
determining, by the one or more processors, a change to at least one of the one or more user attributes and the one or more product parameters;
automatically computing, by the one or more processors, a proximity of the one or more user attributes to the one or more product parameters; and
displaying, by the one or more processors, a graphical indication of the proximity in the one or more graphical interfaces.

19. The system of claim 18, wherein the operations further comprise:
determining an alert respective to a particular product type of the one or more products, the alert indicating a target term for the particular product type;
determining, by the one or more processors, that the target term is satisfied based on the change to the at least one of the one or more user attributes and the one or more product parameters; and
displaying, by the one or more processors, a notification indicating the alert.

20. The system of claim 18, wherein the operations further comprise:
determining guidance information based on the proximity of the one or more user attributes to the one or more product parameters; and
providing the guidance information to the client device.
